(19) United States
(12) Patent Application Publication
(10) Pub. No.: US 2025/0049625 A1
(43) Pub. Date: Feb. 13, 2025

(54) SENSORY SUBSTITUTION DEVICES

(71) Applicant: MAKESENSE TECHNOLOGY LIMITED, Greater London (GB)

(72) Inventors: Robert Quinn, Greater London (GB); Henry de Winton, Greater London (GB); Brandon Robert Ellis-Frew, Greater London (GB); Iain Matthew Russell, Leatherhead (GB)

(21) Appl. No.: 18/719,770

(22) PCT Filed: Dec. 16, 2022
(86) PCT No.: PCT/IB2022/062369

§ 371 Date: Jun. 13, 2024

(30) Foreign Application Priority Data
Dec. 16, 2021 (GB) 2118227.4

(51) Int. Cl. A61H 3/06

(52) U.S. Cl. CPC A61H 3/061; A61H 2003/063; A61H 2201/0153; A61H 2201/169; A61H 2201/5007

(57) ABSTRACT

Sensory substitution devices are provided. A first such device comprises (i) a spatial sensor configured to provide spatial sensor data indicative of a spatial representation of an environment in which the device is located; and (ii) a shape-change mechanism operable to cause the device to change shape, based on the spatial sensor data, to provide kinaesthetic output to a user of the device, wherein the kinaesthetic output is indicative of a target position in the environment. A second such device comprises (i) a sensor operable, in use, to output sensor data representative of an environment in which the device is being used by a user of the device; and (ii) a mechanism operable to cause the device to change shape, based on the output data, with motion that is not plane-constrained, whereby to provide proprioceptive output to the user. Other such example devices are provided.

### FIELD

The present disclosure relates to sensory substitution devices.

### BACKGROUND

Computer vision can identify objects. Simultaneous Localisation and Mapping (SLAM) can map and locate a person within an unknown environment. Both technologies can, in principle, benefit visually impaired people, such as blind people. However, existing devices do not adequately communicate useful information derived using these technologies to visually impaired people.

The reader is referred, in this regard, to WO 2016/116182 A1 and JP 2010057593 A.

### SUMMARY

According to first embodiments, there is provided a sensory substitution device comprising:
a spatial sensor configured to provide spatial sensor data indicative of a spatial representation of an environment in which the sensory substitution device is located; and
a shape-change mechanism operable to cause the sensory substitution device to change shape, based on the spatial sensor data, to provide kinaesthetic output to a user of the sensory substitution device, wherein the kinaesthetic output is indicative of a target position in the environment.

According to second embodiments, there is provided a sensory substitution device comprising:
a sensor operable, in use, to output sensor data representative of an environment in which the sensory substitution device is being used by a user of the sensory substitution device; and
a mechanism operable to cause the sensory substitution device to change shape, based on the output data, with motion that is not plane-constrained, whereby to provide proprioceptive output to the user.

According to third embodiments, there is provided a sensory substitution device comprising:
a shape-change mechanism operable to cause the sensory substitution device to change shape, based on spatial sensor data captured by a spatial sensor, to provide kinaesthetic output to a user of the sensory substitution device, wherein the kinaesthetic output is indicative of a target position.

According to fourth embodiments, there is provided a sensory substitution device comprising:
a force-based mechanism operable to cause the sensory substitution device to provide kinaesthetic output to a user of the sensory substitution device based on spatial sensor data captured by a spatial sensor, wherein the kinaesthetic output is indicative of a target position.

According to fifth embodiments, there is provided a sensory substitution device comprising:
a force-based mechanism operable to cause the sensory substitution device to provide kinaesthetic output to a user of the sensory substitution device, wherein the kinaesthetic output is indicative of a path between the sensory substitution device and a target position, and wherein the path corresponds to a biomechanically optimal path to the target position relative to a different, mathematically and/or spatially optimal path to the target position.

According to sixth embodiments, there is provided a sensory substitution device comprising:
an elongate body; and
a mechanism operable to cause the sensory substitution device to provide kinaesthetic output to a user of the sensory substitution device based on spatial sensor data captured by a spatial sensor, wherein the kinaesthetic output directs the user point the elongate body of the sensory substitution device at a target position.

According to seventh embodiments, there is provided a sensory substitution device comprising:
a mechanism operable to cause the sensory substitution device to provide kinaesthetic output to a user of the sensory substitution device; and
a tilt compensator to compensate the kinaesthetic output for tiling of the sensory substitution device by the user.

According to eighth embodiments, there is provided a sensory substitution device comprising a mechanism operable to cause the sensory substitution device to provide kinaesthetic output to a user of the sensory substitution device, wherein the substitution device is operable to provide kinaesthetic output to guide a user of the sensory substitution device and is also operable to provide kinaesthetic output to alert the user to the presence of an object.

According to ninth embodiments, there is provided a shape-changing sensory substitution device configured to perform non-linear actuation, wherein an amount of shape change of the sensory substitution device correlates non-linearly to an amount of error between a pointing position and a target position.

### BRIEF DESCRIPTION OF THE DRAWINGS

Various embodiments will now be described, by way of example only, with reference to the accompanying drawings in which:

FIG. 1 shows a perspective view an example of a sensory substitution device in three different configurations;

FIG. 2 shows a plan view of the example sensory substitution device shown in FIG. 1;

FIG. 3 shows a perspective view of another example of a sensory substitution device;

FIG. 4 shows an exploded perspective view of the example sensory substitution device shown in FIG. 3;

FIG. 5 shows schematically an example of out-of-plane shape-changing motion;

FIG. 6 shows a schematic representation of example items associated with an example sensory substitution device;

FIG. 7 shows a perspective view of another example of a sensory substitution device;

FIG. 8 shows a perspective view of another example of a sensory substitution device in three different configurations, the example sensory substitution device comprising a tilt compensator;

FIG. 9 shows a perspective view of another example of a sensory substitution device in five different configurations;

FIG. 10 shows a perspective view of another example of a sensory substitution device;

FIG. 11 shows a schematic representation of an example of an environment in which another example of a sensory substitution device is being used;

FIG. 12 shows a schematic representation of another example of an environment in which another example of a sensory substitution device is being used;

FIG. 13 shows several schematic representations of another example of a sensory substitution device being held in different ways;

FIG. 14 shows a perspective view of another example of a sensory substitution device attached to a cane;

FIG. 15 shows a schematic representation of a system comprising another example of a sensory substitution device; and

FIG. 16 shows a perspective view of another example of a sensory substitution device.

### DETAILED DESCRIPTION

As explained above, existing devices do not adequately communicate useful information derived using technologies such as computer vision and SLAM to visually impaired people. In particular, such existing devices do not adequately convey such information non-visually.

Some assistive technology products can identify objects using computer vision and can provide low-resolution alerts about obstacles. Such products include smart canes, smart glasses and smartphone applications which use audio cues and vibration. Audio cues allow users to find locations. However, this form of feedback is ambiguous and can obscure important environmental sounds and social interactions. Vibratory sensations are cognitively distracting, can lead to short-term numbness, and have a low information bandwidth. While vibration may be effective for providing alerts, it is not as effective for conveying complex information such as direction or distance. Without significant advancements in the human-machine interface, smartphone applications, smart canes and smart glasses are not effective enough to approach the functionality of a guide dog.

Shape-changing, haptic interfaces for visual impairment are known. Known interfaces can change shape in the hand of a user to communicate information, such as which heading the user should walk on. Such known interfaces use Bluetooth™ beacons and Global Positioning System (GPS), rather than computer vision or SLAM, to accomplish this. Such interfaces also have limited shape-changing capabilities. For example, they may have a part that can rotate relative to another part and slide forward and backward, whilst constrained to move in a single 2D plane, here called “plane-constrained”. The inability of the mechanism to move out-of-plane, in other words out of that 2D plane and freely in the 3D space around the interface, restricts not only the amount of information that can be conveyed to the user but also the intuitiveness of use of such interfaces.

Various other drawbacks to such existing interfaces will now be described.

GPS is generally only accurate to ±5 metres. This is not accurate enough to replace a guide dog. For example, a user cannot be directed to stay on a pavement.

GPS also relies on receiving GPS signals from GPS satellites. This is not possible in some environments, such as environments that are deep underground.

Bluetooth™ beacons need to be installed in the locations where the existing interfaces are being used. This may involve changes to that environment and may mean that such interfaces can only be used in locations in which Bluetooth™ beacons have already been installed.

Neither Bluetooth™ beacons nor GPS can be used to detect and navigate around temporary obstacles, such as dustbins.

Such existing interfaces are not optimised to direct users to point at objects in 3D space. Instead, they are optimised for directing a walking heading.

Such existing interfaces use geared mechanisms and screw-driven actuators to actuate shape changes. As a result, such interfaces are relatively large and heavy, and have relatively low responsiveness.

The motion of such existing interfaces is not particularly organic and is not designed to be arrested by the grip of the user, in other words held tightly by the user.

A user cannot use such existing interfaces to point at and identify objects.

One existing interface is in the form of a candlestick-type device, which is elongate and held vertically. In contrast, example devices described herein may be designed to be held horizontally. Such devices are more intuitive for pointing.

Additionally, example devices described herein may primarily communicate angles, for example for communicating pointing and direction. This differs from communicating translational movement only, for example movement through space. However, example devices described herein may nevertheless incorporate a modality that enables distance information to be delivered to a user, for example using vibration, sound, other haptic features, etc.

Further, example devices can comprise shape-change functionality at the front of the device such that a thumb and forefinger of a user can detect shape-change, while the bulk of the device can be held in the palm of the user. With the thumb and forefinger being particularly sensitive, enhanced proprioceptive output may be provided, as will be described in more detail below.

Further, some example devices described herein comprise and/or leverage one or more forward-facing spatial sensors. Such sensors have a viewing perspective indicative of the pointing direction of the user. This contrasts to previous designs, such as the candlestick-type device, where there are no such spatial sensor locations.

Space constraints and difficulties in mechanical design are typically the major limiting factor in design of state of the art shape-changing interfaces. Spatial sensors, such as optical and radio wave sensors, are constrained in their potential placement locations on the device and are significantly larger than previously used sensors, such as GPS and inertial measurement units (IMUs). This contravenes the design trends in the state of the art by increasing the mechanical and/or space constraints posed when designing haptic interfaces, such as handheld haptic interfaces.

Various terms will be used in conjunction with examples described below. Such terms will now be explained.

The term “environment” encompasses different types of environments, such as real-world and digital environments. For example, example devices described herein may be used as game controllers.

In some examples, a device in accordance with examples is located in a real-world environment. The device may use spatial sensor data indicative of a spatial representation of the (real-world) environment in which the sensory substitution device is (physically) located. The device may, for example, orient itself to point to an object in that real-world environment.

In some examples, a device in accordance with examples is located in a digital (or “virtual”) environment. The device may use spatial sensor data to cause the device to change shape to provide kinaesthetic output indicative of a target position. The target position may be a digital target position, not detected by the spatial sensor. The device may, for example, orient itself to point to a digital object in that digital environment. The device may also be able to find digital waypoints, and the like, which are not directly detected by the spatial sensor.

The term “augmented reality” (AR) is used herein to relate generally to using digital content in real-world experiences, such as guiding a user to virtual target placed relative to real-world space.

The term “computer vision” is used herein to relate generally to identifying one or more objects or people from camera footage, or to make inferences about an environment such as identifying pavement versus road, or grass versus tarmac. As such, computer vision can encompass “classification”. Classification may be either of an entire frame or of a subregion of a frame (also called “semantic segmentation”). Computer vision also includes functionality such as, but not limited to, 3D pose estimation, motion estimation and scene modelling. These types of computer vision do not return a heuristic understanding of a scene, such as an object being a road. However, they still enable significant functionality, such as teleassistance and tracking of pre-set markers. Both of these use cases can, conceivably, be achieved using computer vision without any heuristic identification that may usually be associated with computer vision. Computer vision may also encompass visual odometery. Visual odometry is especially useful for 3D pose estimation, namely finding position and orientation in 3D space, which is especially effective for SLAM.

The term “LIDAR”, which stands for light detection and ranging, is used herein in relation to technology used to measure distances and build a point-cloud of an environment.

The term “point cloud” is used herein to mean a series of depth measurements derived from a LIDAR, ultrasonic, RADAR, SONAR or other spatial sensor scan that can be used to build a 3D computer model of an environment.

The term “haptic” is used herein, in relation to a device, to mean a device which communicates information through the touch sense.

The term “digital marker” is used herein to refer to a point in space which has been digitally recorded or generated. Examples include, but are not limited to GPS locations, AR anchors in software, or a location relative to a device's position.

The term “AR Anchor” is used herein in relation to digital markers placed within specific software suites, such as ARkit™ by Apple™ and ARCore™ by Google™.

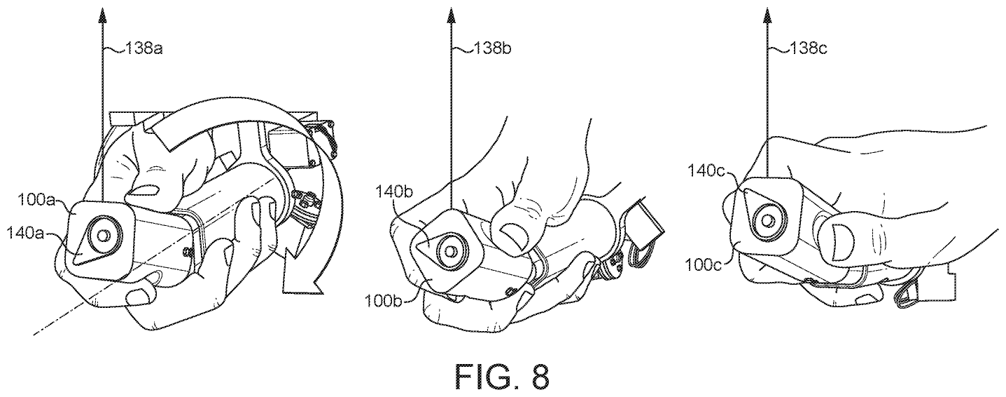

The term “tilt” is used herein to refer to roll of a device about its length, such as when a user rolls their wrist. Tilt and tilt compensation will be described below in more detail with reference to FIG. 8.

The term “vector” is used herein to refer to a quantity with both magnitude and direction.

The term “pointing vector” is used herein to mean the unit vector along which the device is currently pointing.

The term “target vector” is used herein to mean the vector between the device and the target position.

The term “error” is used herein to mean the angle between the pointing vector and the target vector.

The terms “proprioception”, “kinaesthesia” and “kinesthesia” are used herein interchangeably to mean the sense of self-movement and body position.

The terms “modality” and “sensory modality” are used herein interchangeably to mean a type of stimulus or what is perceived after such a stimulus. Examples of sensory modalities include, but are not limited to, smell, taste, touch, vision and hearing.

The term “sensory substitution” is used herein to mean passing information that is normally gathered by one sensory modality (such as vision) through the modality of another (such as touch).

The terms “shape change”, “change shape”, “change of shape” and the like are used herein to mean a change to at least one property of a shape. A shape change may, for example, result in a change in at least one dimension of the shape, with the geometric shape remaining the same. For example, a change of shape may encompass a cylindrical shape changing from having a first length to a second length. A shape change may, for example, result in a change of geometric shape.

The terms “device” and “interface” are used interchangeably.

The term “spatial sensor” is used herein to mean any type of sensor that can be used to sense a spatial environment, such as spatial information of such an environment. For example, LIDAR, RADAR and optical cameras primarily return information about the space towards which they are pointed; not the body on which they are mounted. IMUs and GPS modules, on the other hand, primarily return information about the body to which they are attached, not information about the surrounding space, and so are not spatial sensors.

The term “sensor” is used herein more generally to mean any type of sensor.

The term “spatial sensor data” is used herein to mean any type of data provided or output by a spatial sensor. The term “sensor data” is used herein more generally to mean any type of data provided or output by any type of sensor.

The term “target position” is used herein to mean any position in 3D space that is a target for a sensory substitution device, a user of a sensory substitution device, or another device or person to locate. An example of a target position is a digital marker placed on an object or an intermediary point along a path. The target position is not a position on the sensory substitution device itself. In some examples, the sensory substitution device is configured to point towards the target position.

The term “forward-facing” is used herein to mean facing forwards with respect to the front of the device. This may correspond to facing in a direction of a target position in some situations, but the target position may be behind the user in other situations.

The term “SLAM”, which stands for Simultaneous Localisation and Mapping, is used herein to relate to the process of using spatial sensor data to construct or update a map of an environment, whilst simultaneously keeping track of the location of a user within the environment. This can also be used to help keep track of targets set by a user and/or by another entity.

The term “plane-constrained” is used herein, in connection with a device, to mean freedom of movement which is constrained to a single 2D plane that has its frame of reference on the device. For example, plane-constrained motion may allow left and right movement, forwards and backwards movement, and rotation whilst remaining constrained to one 2D plane, but not movement upwards and downwards as this would move out of the 2D plane and into 3D space. Motion that is not plane-constrained may move out of a 2D plane and into 3D space. Such motion may be referred to as “out-of-plane” motion.

The term “shape-change mechanism” is used herein to mean a mechanism that changes a shape. The shape-change mechanism may comprise a “shape-changing mechanism” which changes its own shape and thereby the shape of a device in which it is incorporated. However, a shape-change mechanism may change the shape of a device in which it is incorporated without changing its own shape.

The term “device axis” or “device centre line” is used herein to refer to a line approximately along the longitudinal axis of the device, representing the home position or straight position of the device.

Examples described herein provide navigation technology in the form of a device that changes shape. Humans have a natural ability to interpret object shapes with their hands, such as whether an elongate object is curved to the right or to the left, for example. This ability is exploited to communicate navigation information non-visually. Such information is communicated via the touch sense and can be used to indicate 3D locations. The user can follow the direction of curvature thereby directing the user to point in a desired direction. Such examples exploit the combination of the ability of humans (i) to sense the location of their extremities non-visually (proprioception) and (ii) to infer 3D locations by pointing with their hands. Pointing with the hands is a natural human gesture which is observed even in congenitally blind children who cannot observe and learn this behaviour from other humans. It is therefore a surprisingly effective way of communicating vectorised information to visually impaired persons. Directing the user to point in a desired direction may correspond to directing the user to orient a longitudinal axis of the device towards a target position.

Examples described herein also provide a handheld sensory substitution device which uses a shape-changing, haptic interface in combination with computer vision and/or LIDAR to direct a user towards one or more locations and/or one or more objects of interest by prompting the user to point their hand, and hence the device, in the direction of the object(s) and/or location(s) of interest. Examples may, however, still use only GPS and/or only an IMU for controlling the device.

Examples also provide a new human-machine interface that can direct users towards objects and/or locations of interest by passing information through the sense of touch via shape changes. In examples, the interface is in the form of a sensory substitution device. The sensory substitution device may bend in two or more dimensions whilst held in the hand, aiming or pointing in the desired direction. The user can sense which direction the device is pointed in via the shape change and can intuitively follow this guidance. This non-visually conveys direction to users through the touch sense with minimal prior knowledge and minimal training. Prompting a user to point in the desired direction works with their innate non-visual spatial interpretation capabilities. Examples, therefore, reduce an intractable problem of describing 3D navigation with audio cues or vibration sensations into an intuitive and straightforward experience for visually impaired people.

Examples described herein also provide a handheld device with forward-facing LIDAR, which scans the environment in which the device is located to build a local 3D computer model in the form of a point cloud. The point cloud is used in isolation, or is combined with computer vision using SLAM to construct a map of the local environment the user is walking through while simultaneously keeping track of the location of the user within that environment. Relevant navigation information is then passed to the user through their touch sense using an advanced, shape-changing haptic interface. This augments the capabilities of GPS to provide enhanced and intuitive local guidance, for example keeping a person on a pavement, directing a person to a platform, or dealing with temporary obstacles such as other people or dustbins. This can be provided without modifications to infrastructure. The computer vision capability may, for example, identify bus stops, bus numbers and train doors. Computations, such as SLAM computations, may be performed on a connected device, such as a smartphone, to keep costs of the interface low and accessibility high.

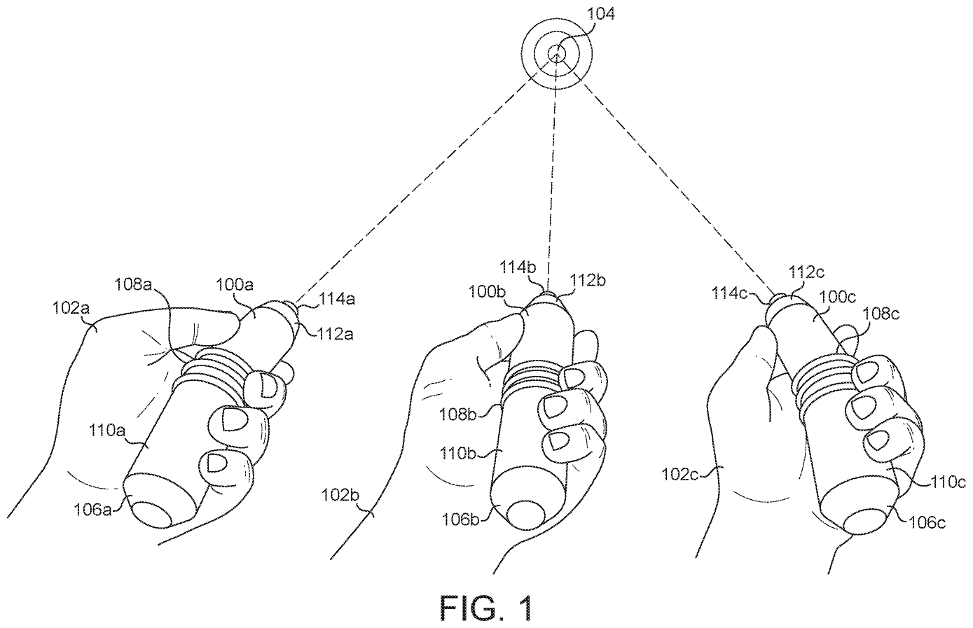

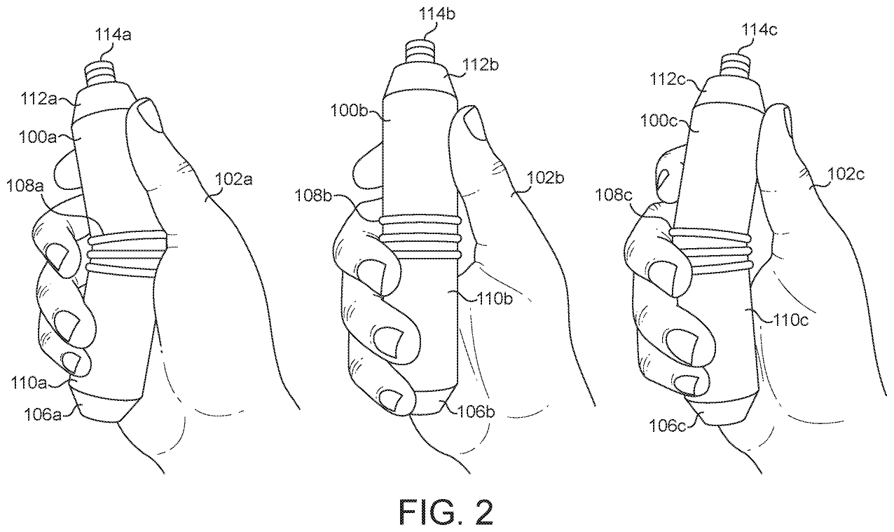

Referring to FIGS. 1 and 2, there is shown an example of a sensory substitution device (also referred to herein as a “device” for convenience and brevity) in three different configurations.

In FIG. 1, the device is indicated with reference signs 100a, 100b, 100c in the first, second and third configurations respectively.

In use, the device 100a, 100b, 100c is held and gripped by a user. In FIG. 1, the user is indicated with reference signs 102a, 102b, 102c when the device is in the first, second and third configurations respectively.

In use, the device 100a, 100b, 100c is located in an environment. The environment comprises a target position 104. The target position 104 is, in this example, a position in 3D space, which is being targeted by the user 102a, 102b, 102c and/or another entity. The target position 104 may correspond to a target object and/or a target location.

In the first configuration, the device 100a is bent to the right and points at the target position 104. In the second configuration, the device 100b is straight and points at the target position 104. A straight device shape is easily sensed by the hand of the user 102b which provides an unambiguous indication that the user 102b is pointing directly at the target position 104. In the third configuration, the device 100c is bent to the left and points at the target position 104.

In this example, the device 100a, 100b, 100c is a handheld device. This provides a highly portable device, which can readily leverage proprioception. In use, the user 102a, 102b, 102c holds the device in their hand 100a, 100b, 100c like a flashlight. The user 102a, 102b, 102c can point the device 100a, 100b, 100c in any direction.

In this example, the device 100a, 100b, 100c comprises a rear portion. In FIG. 1, the rear portion is indicated with reference signs 106a, 106b, 106c in the first, second and third configurations respectively.

In this example, the device 100a, 100b, 100c comprises an exposed shape-change mechanism portion. In FIG. 1, the exposed shape-change mechanism portion is indicated with reference signs 108a, 108b, 108c in the first, second and third configurations. The exposed shape-change mechanism portion 108a, 108b, 108c is exposed in that it is at the surface of the device 100a, 100b, 100c. As will be explained in more detail below, other elements of the shape-change mechanism are within the device 100a, 100b, 100c.

In this example, the device 100a, 100b, 100c comprises a gripping portion. In FIG. 1, the gripping portion is indicated with reference signs 110a, 110b, 110c in the first, second and third configurations respectively. In this example, the gripping portion comprises multiple gripping regions, with a first one of the gripping regions being on one side of the exposed shape-change mechanism portion 108a, 108b, 108c and the other one of the gripping regions being on the other side of the exposed shape-change mechanism portion 108a, 108b, 108c. The gripping portion 110a, 110b, 110c is designed and configured to be gripped by the user 102a, 102b, 102c. This results in the device 100a, 100b, 100c being convenient to use. In addition, hands are the best-suited part of the body to receive and interpret the shape-changing output of the device 100a, 100b, 100c. In this example, the gripping portion 110a, 110b, 110c extends most of the length of the device 100a, 100b, 100c. The exposed shape-change mechanism portion 108a, 108b, 108c may form part of the gripping portion 110a, 110b, 110c if it is intended to be gripped by the user 102a, 102b, 102c.

In this example, the device 100a, 100b, 100c comprises a front portion. In FIG. 1, the front portion is indicated with reference signs 112a, 112b, 112c in the first, second and third configurations respectively.

The rear portion 106a, 106b, 106c, the exposed shape-change mechanism portion 108a, 108b, 108c, the gripping portion 110a, 110b, 110c and the front portion 112a, 112b, 112c collectively define a body of the device 100a, 100b, 100c.

The user 102a, 102b, 102c can direct the device 100a, 100b, 100c to find one or more target objects and/or locations 104. Such object(s) 104 may be common (also referred to as “everyday”) objects, environmental features such as pavements and roads, or otherwise.

The device 100a, 100b, 100c may comprise a microphone. Alternatively or additionally, one or more other devices to be used with the device 100a, 100b, 100c may comprise a microphone. In examples, the user 102a, 102b, 102c can control the device 100a, 100b, 100c using only their voice, for example though natural language processing. In examples, the user 102a, 102b, 102c can therefore verbally describe their intentions to a controller (comprised in the device 102a, 102b, 102c or another device) using natural language processing. For example, the user 102a, 102b, 102c could ask the device 100a, 100b, 100c to find them a door, or take them to a particular train platform. This may, for example, help the user 102a, 102b, 102c navigate through public transport networks, without modifications to network infrastructure. As such, in some examples, the target position 104 is identified based on processing a voice input using natural language processing. This provides an especially effective input modality for visually impaired people.

The user 102a, 102b, 102c then points the device 100a, 100b, 100c in directions where the target object and/or location 104 is suspected to be positioned.

In this example, the device 100a, 100b, 100c comprises a spatial sensor. In FIG. 1, the spatial sensor is indicated with reference signs 114a, 114b, 114c when the device is in the first, second and third configurations respectively. The spatial sensor 114a, 114b, 114c is, in this example, configured to provide spatial sensor data indicative of a spatial representation of an environment in which the device 100a, 100b, 100c is located.

In this example, the spatial sensor 114a, 114b, 114c is in the front portion 112a, 112b, 112c of the device 100a, 100b, 100c. Such a spatial sensor 114a, 114b, 114c may be referred to as “forward-facing”. As such, the spatial sensor 114a, 114b, 114c may be placed on the front of the device 100a, 100b, 100c. In such examples, the spatial sensor 114a, 114b, 114c has a viewing perspective indicative of the pointing direction of the user 102a, 102b, 102c. By the spatial sensor 114a, 114b, 114c having the same perspective as the pointing direction, the device 100a, 100b, 100c can readily and easily orient itself such that the target position 104 is in the middle of a field of view of the spatial sensor 114a, 114b, 114c and, hence, may be in the middle of a camera frame when the user 102a, 102b, 102c points their hand at the target position 104.

In this example, the spatial sensor 114a, 114b, 114c comprises a camera. However, other types of spatial sensor may be used. Examples of other types of spatial sensor include, but are not limited to, LIDAR, ultrasonic and infrared sensors. As such, in some examples, the target position 104 is determined using computer vision and/or LIDAR. This enables the device 100a, 100b, 100c to be used to identify and locate objects, to perform SLAM, and to map environments. However, ultrasound can also be used to map environments, and infrared enables the device 100a, 100b, 100c to be used in the dark. The latter may be effective whether the device 100a, 100b, 100c is used by a visually impaired person or by a person who is not visually impaired.

The spatial sensor 114a, 114b, 114c may have an ultrawide (or “ultra-wide”) field of view, where the sensor 114a, 114b, 114c has an angle of view of greater than 100 degrees. This facilitates objects remaining within the field of view of the spatial sensor 114a, 114b, 114c despite device movement. Where the device 100a, 100b, 100c comprises multiple spatial sensors 114a, 114b, 114c, one or more of the spatial sensors 114a, 114b, 114c may have an ultrawide field of view and one or more others of the spatial sensors 114a, 114b, 114c may not have an ultrawide field of view. This also enables a target vector, between the spatial sensor 114a, 114b, 114c and the target position 104, to be kept within the line of sight of the spatial sensor 114a, 114b, 114c even when the device 100a, 100b, 100c and/or the user 102a, 102b, 102c moves.

The device 100a, 100b, 100c may comprise one or more light sources. This may enhance use of the device 100a, 100b, 100c in dark environments. In particular, computer vision efficiency is heavily dependent on lighting conditions. The device 100a, 100b, 100c may comprise one or more infrared light sources. This may be especially effective where the device 100a, 100b, 100c comprises one or more infrared cameras. Through computer vision, the camera 114a, 114b, 114c ‘looks’ for the object(s) of interest 104. In this example, the device 100a, 100b, 100c and/or another device analyses the camera frame (in other words, an image captured by the camera 114a, 114b, 114c). The camera 114a, 114b, 114c can therefore capture data that can be interpreted to identify objects 104 using computer vision. In this example, the device 100a, 100b, 100c comprises object identification functionality. However, object identification functionality may be provided in another device to be used with the device 100a, 100b, 100c. More specifically, in this example, the device 100a, 100b, 100c is operable to identify objects when the device 100a, 100b, 100c is pointed at them. It can be more convenient and natural for the user 102a, 102b, 102c to point, compared with using a device such as a smartphone, to identify such objects.

Using computer vision in this manner enables the user 102a, 102b, 102c to be located in 3D space within an unknown local environment and enables the user 102a, 102b, 102c to navigate through the unknown environment using SLAM. Specifically, in this example, the device 100a, 100b, 100c is configured to be controlled using SLAM. This enables the device 100a, 100b, 100c to provide spatial guidance in any environment.

Identified objects 104 may also be tracked.

The device 100a, 100b, 100c changes shape via a shape-change mechanism. The shape-change mechanism is operable to cause the device 100a, 100b, 100c to change shape, based on the spatial sensor data provided by the camera 114a, 114b, 114c (and/or another type of spatial sensor), to provide kinaesthetic output to the user 102a, 102b, 102c of the device 100a, 100b, 100c. The kinaesthetic output is indicative of a target position 104 in the environment. As such, the device 100a, 100b, 100c indicates to the user 102a, 102b, 102c where the object 104 is in 3D space. More specifically, the device 100a, 100b, 100c indicates to the user 102a, 102b, 102c where the object 104 is in 3D space relative to the user 102a, 102b, 102c.

If the object 104 is identified within the camera frame and if the device 100a, 100b, 100c is not already pointing at the object 104, the device 100a, 100b, 100c changes shape in the hand of the user 102a, 102b, 102c to point at the object 104. The user 102a, 102b, 102c can feel the change in shape of the device 100a, 100b, 100c as a result of them gripping and holding the device 100a, 100b, 100c. More specifically, in this example, the user 102a, 102b, 102c can feel the change of shape of the device 100a, 100b, 100c in the gripping portion 110a, 110b, 110c of the device 100a, 100b, 100c. After feeling which direction the shape of the device 100a, 100b, 100c is pointed towards, the user 102a, 102b, 102c can move their hand in this direction. When moving their hand, and hence the device 100a, 100b, 100c, the user 102a, 102b, 102c is receiving kinaesthetic output. This kinaesthetic output is used to infer direction.

The change of shape may be in at least one degree of freedom. This may enable the device 100a, 100b, 100c to indicate depth or distance.

The change of shape may be in at least two degrees of freedom. This may enable the device 100a, 100b, 100c to point in any direction and, therefore, indicate direction.

The change of shape may be in three degrees of freedom. This may enable the device 100a, 100b, 100c to point in any direction, as well as indicate depth, distance or heading.

In this example, the change of shape comprises bending of the device 100a, 100b, 100c. This provides a natural-feeling shape change.

In this example, the change of shape also comprises stretching and/or compressing of the device 100a, 100b, 100c. This enables the device 100a, 100b, 100c to indicate distance or heading. However, distance or heading can be indicated in another manner in other examples, as will be described in more detail below.

More generally, the shape change may be performed through bending and/or stretching in at least two degrees of freedom whilst the device 100a, 100b, 100c is held in the hand. For example, the device 100a, 100b, 100c may be able to bend left, right, up and/or down. This enables the device 100a, 100b, 100c to point in any direction. The device 100a, 100b, 100c may be able to stretch forwards and compress backwards. The device 100a, 100b, 100c can indicate a distance (for example to the object 104) or heading based on the extent of stretching and/or compression and/or in another manner.

In this example, the device 100a, 100b, 100c comprises an elongate body, and the shape-change mechanism is operable to cause the elongate body of the device 100a, 100b, 100c to change shape by changing straightness and/or length. This enables intuitive pointing.

In this example, the device 100a, 100b, 100c comprises a microcontroller (not visible) and the microcontroller is configured to control the shape-change mechanism based at least in part on the spatial sensor data. This can provide high-speed control when converting the spatial input into a shape-changing output. The control of the shape-change mechanism may also be based on IMU data. For example, IMU data may be used to perform tilt compensation such as described below with reference to FIG. 8.

The device 100a, 100b, 100c may notify the user 102a, 102b, 102c that the object 104 has been identified and/or that the user is pointing the device 100a, 100b, 100c towards the target position 104. Such a notification may be delivered when the user is pointing relatively near to the target position 104, for example within seven degrees. Such notification may be via a vibratory alert or otherwise. The alert may or may not be persistent. For example, a persistent alert could be a vibration or auditory signal which persists or persistently repeats whilst the device 100a, 100b, 100c remains pointed close to the target position 104. As such, the device 100a, 100b, 100c may be operable to provide a vibratory output. This enables the device 100a, 100b, 100c to provide alerts and other signals to the user 102a, 102b, 102c.

In some examples, the device 100a, 100b, 100c and/or another device comprises a loudspeaker. In some examples, once the device 100a, 100b, 100c has directed the user 102a, 102b, 102c to point in a direction of interest, the device 100a, 100b, 100c verbally communicates the distance to the object of interest 104. For example, whilst pointed at a coffee cup, the device 100a, 100b, 100c could communicate “the cup is 60 centimetres away”. Such verbal communication may be an alternative to, or may be in addition to, the stretching and/or compression to indicate distance or heading and/or other haptic modalities. As such, in some examples, the device 100a, 100b, 100c is operable to communicate verbally a distance from the device 100a, 100b, 100c to the target position 104. Once the user 102a, 102b, 102c is pointed at the target position 104, in 3D space, two out of three dimensions are removed for locating the target position 104. The only remaining dimension is distance.

If the device 100a, 100b, 100c is already pointed directly at the object 104, the device shape is straight. In this example, the shape-change mechanism is configured such that the device 100a, 100b, 100c is substantially straight when the device 100a, 100b, 100c is pointed at the target position 104 in the environment. This can be best seen in the device 100b in the second configuration. The term “substantially straight” is used herein to mean generally linear from the perspective of the user 102a, 102b, 102c, for example as opposed to being curved or bent. The device 100a, 100b, 100c may therefore be substantially straight without being perfectly linear. This enables the device 100a, 100b, 100c to provide an unambiguous indication of 3D spatial direction or 3D object location.

In this example, at least a portion of the device 100a, 100b, 100c is substantially cylindrical. Specifically, in this example, at least the gripping portion 110a, 110b, 110c of the device 100a, 100b, 100c is substantially cylindrical. The symmetry and the proprioceptive output enable the device 100a, 100b, 100c to be used in any orientation. The term “substantially cylindrical” is used herein to mean having generally parallel sides and having a generally circular cross-section. The device 100a, 100b, 100c may therefore be substantially cylindrical without being perfectly cylindrical. For example, as can be seen in FIGS. 1 and 2, the exposed shape-change mechanism portion 108a, 108b, 108c of the device 100a, 100b, 100c may result in a portion the device 100a, 100b, 100c deviating from being perfectly cylindrical while still being substantially cylindrical. Additionally, in this example, the back portion 106a, 106b, 106c and the front portion 112a, 112b, 112c of the device 100a, 100b, 100c are not cylindrical.

In this example, the device 100a, 100b, 100c is operable to be controlled by at least one person other than the user 102a, 102b, 102c while the user 102a, 102b, 102c is using the device 100a, 100b, 100c. For example, the device 100a, 100b, 100c may be controlled by voice commands by the other person. The device 100a, 100b, 100c may alternatively or additionally be controlled by a device of the other person. The device of the other person may be an electronic device such as a computer, smartphone, tablet or another shape-changing haptic interface. For example, the other person may use a smartphone to identify the target position 104. This enables the other person, such as a remotely located person, to help the user 102a, 102b, 102c navigate. This will be explained in more detail below.

Although, in this example, the device 100a, 100b, 100c analyses the camera frame, one or more other devices may perform such analysis, in addition to or as an alternative to the device 100a, 100b, 100c performing such analysis. For example, the device 100a, 100b, 100c may pair with a mobile computing device which performs the SLAM and computer vision computations, and/or provides other sensory input such as GPS co-ordinates or device orientation data. Examples of such mobile computing devices include, but are not limited to, smartphones, tablet computing devices, and laptop computing devices. The device 100a, 100b, 100c may pair with such other devices wirelessly, for example using Bluetooth™, or otherwise. The use of such other devices helps keeps the size and/or weight and/or costs of the device 100a, 100b, 100c low and enables over-the-air updates to the device 100a, 100b, 100c without the device 100a, 100b, 100c having capability to receive such updates directly.

If the user 102a, 102b, 102c grips the device 100a, 100b, 100c tightly such that it cannot change shape, the user 102a, 102b, 102c may still feel the force indicating where the shape-change mechanism is trying to bend the device 100a, 100b, 100c towards, without damaging the shape-change mechanism.

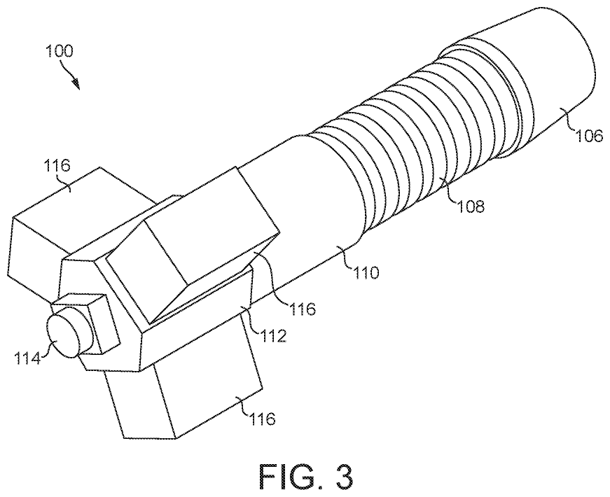

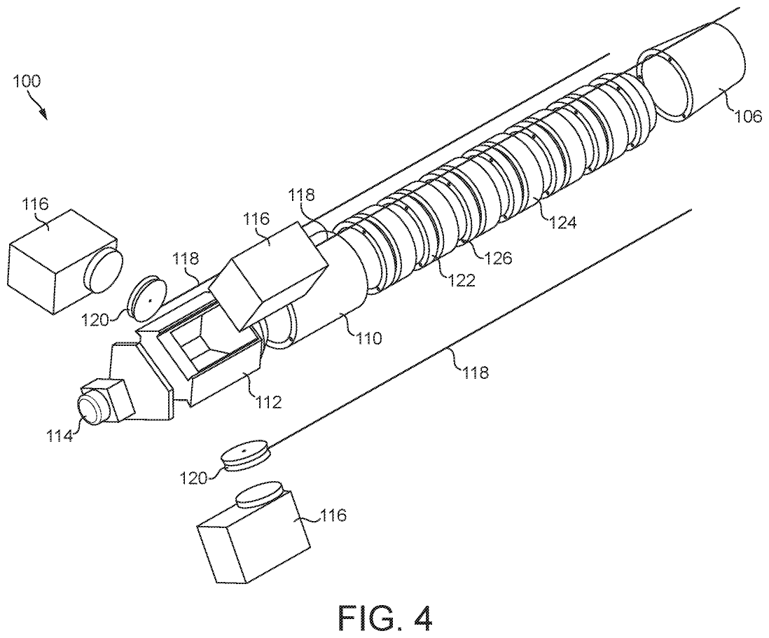

Referring to FIGS. 3 and 4, there is shown another example of a sensory substitution device 100.

In this example, the gripping portion 110 has a single gripping region between the exposed shape-change mechanism portion 108 and the front portion 112. However, the user of the device 100 may nevertheless also use the rear portion 106 and/or the exposed shape-change mechanism portion 108 to grip the device 100. The rear portion 106 and/or the exposed shape-change mechanism portion 108 may therefore be considered to form part of the gripping portion 110.

In this example, the shape changes are accomplished by three electrical motors 116 arranged on the front portion 112 of the device 100. In this example, the electrical motors 116 are equally spaced circumferentially around, and protrude outwardly from, the front portion 112 of the device 100. A different number of motors 116 can be used in other examples. The position of the motor(s) 116 can be different in other examples.

In this example, each motor 116 variably tensions a respective one of three antagonistic tendons 118 which run up the length of the device 100. A different number of antagonistic tendons 118 can be used in other examples. In this example, each motor 116 drives a respective pulley 120. Only two pulleys 120 are shown in FIG. 4, it being understood that three pulleys 120 are present in this specific example. In this example, each antagonistic tendon 118 is drawn in around its respective pulley 120 when its respective motor 116 is driven in one direction and is allowed to be drawn out from its respective pulley 120 as its respective motor 116 is driven in the other direction. Alternatively, all three pulleys 120 may draw in or pull out simultaneously to cause the device 100 to retract or extend along its length.

More generally, at least two electrical motors 116 and at least two antagonistic tendons 118 may be used. However, if three independent antagonistic tendons 118 are used, the device 100 can compress and elongate, as well as bend.

As such, in this example the shape-changing device 100 is driven by motors 116 and antagonistic tendons 118. This may be more compact, faster-moving and cheaper than other possible mechanisms.

The motors 116 may readily be controlled by software.

In this example, the device 100 comprises a shape-changing membrane, the surface of which corresponds to the external shape-change mechanism portion 108. In this example, the shape-changing membrane comprises alternating flexible vertebrae 122 and rigid vertebrae 124. In this example, the flexible and rigid vertebrae 122, 124 are ring-shaped.

In this example, each antagonistic tendon 118 passes through a respective one of three holes 126 in each of the gripping portion 110, the flexible vertebrae 122, the rigid vertebrae 124, and the end portion 106. In FIG. 4, one such hole is indicated with reference sign 126, it being understood that other holes are shown in FIG. 4.

This arrangement results in a device body which can change shape in three degrees of freedom. In particular, the device body can bend left, right, up and down, and extend forwards and backwards, or some combination of each degree.

In this example, the flexible vertebrae 122, and hence the shape-change mechanism, comprises elastomeric material. The elastomeric material enables the shape-changing membrane to compress, expand, and bend. The elastomeric material also reduces the likelihood of, or even prevents, the shape-change mechanism from pinching the hand of the user when the device 100 changes shape. In examples, the device 100 comprises a sheath to cover the shape-change mechanism 108. The sheath may be corrugated. The sheath may prevent the user from being pinched while still allowing movement of the shape-change mechanism. The sheath may prevent ingress of outside material into the shape-change mechanism, reducing maintenance and increasing longevity. The sheath may play a mechanical role in the shape-change mechanism. The sheath may, alternatively, cover the shape-change mechanism.

In this example, the motors 116, antagonistic tendons 118, flexible vertebrae 122 and rigid vertebrae 124 all form part of the shape-change mechanism.

As can best be seen in FIG. 4, in this example, the end portion 106, the gripping portion 110, the flexible vertebrae 122 and the rigid vertebrae 124 are hollow. This provides a lightweight device 100, which uses relatively small amount of material, while still being sufficiently rigid for the intended use. The hollow centre of the device 100 can comprise other components of the device 100.

In this example, the shape-change mechanism is configured to cause the device 100 to return to an equilibrium shape when the device 100 is powered off. In this example, when the device 100 is powered off, the elastomeric material relaxes to its equilibrium state, and the motors 116 allow the antagonistic tendons 118 to unwind from the pulleys 120 such that the device 100 returns to being straight. The device 100 has, in effect, a self-righting design, which returns the device 100 to the straight, equilibrium configuration when the device 100 is powered off. This enables the device 100 to be more ergonomic and the device 100 better fits in a pocket of the user if the device 100 runs out of power.

The device 100 may comprise one or more end-stop sensors to align the straight position. The end-stop may be a “home” position. The device 100 may comprise a locking mechanism to fix the device 100 in the home position when not in use.

In some examples, three or more independently actuated tendons 118 are used. This enables the tendons 118 to be automatically tensioned. This also enables ease of assembly.

In some examples, two or more tendons 118 with two or more independent actuators are used. This enables non-plane-constrained shape-change.

In some examples, the pulleys 120 are deeply grooved pulleys 120. Such pulleys 120 may be used in combination with fixed-length tendons 118. This may reduce or remove the possibility of the tendons 118 slipping off the pulleys 120.

In some examples, the device 100 comprises low-friction sleeving. An example of low-friction sleeving is a polytetrafluoroethylene (PTFE) tube. Tendons 118 may be routed through such low-friction sleeving. The sleeving diameter may be substantially the same as the diameter of the antagonistic tendon 118 to limit play.

The device 100 may comprise a rotationally constraining linkage. The rotationally constraining linkage restricts the device 100 to having no torsional degrees of freedom. The rotationally constraining linkage may surround the actuator(s). Alternatively, the rotationally constraining linkage may be surrounded by the actuator(s). A stiff sheath may double as such a linkage by being bendable but not twistable. Such a sheath may be made of rubber, for example. In more detail, in examples, the shape-change mechanism is linked by a joint that does not allow rotation but enables pan and tilt motions. Examples of such a joint include, but are not limited to, a universal linkage and a flexible shaft.

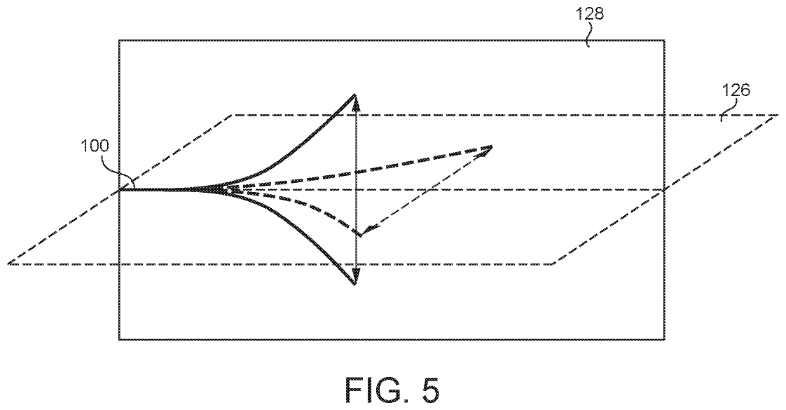

Referring to FIG. 5, there is shown another example of a sensory substitution device 100.

FIG. 5 demonstrates how the device 100 can change shape with motion that is not plane-constrained, whereby to provide proprioceptive output to a user. In FIG. 5, a first 2D plane is indicated with reference sign 126 and using broken lines, and a second 2D plane is indicated with reference sign 128 and using solid lines. In this example, the device 100 can change shape with motion that is not plane-constrained. In particular, the motion is not constrained to being in only one of the first or second planes 126, 128. Instead, the motion can be in either of the first or second planes 126, 128, or outside of the first and second planes 126, 128 in the 3D space surrounding the device 100. However, the device 100 may have plane-constrained motion in other examples.

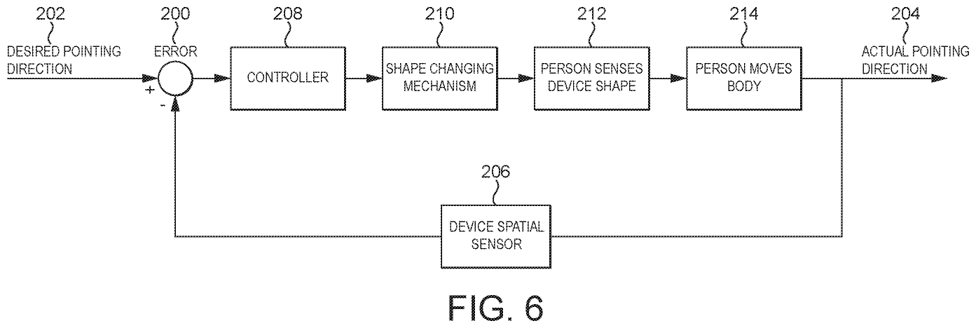

Referring to FIG. 6, at item 200, an error is calculated as a difference between a desired pointing direction 202 and an actual pointing direction 204. In this example, the actual pointing direction 204 is determined by a device spatial sensor 206. In this example, a controller 208 controls a shape-change mechanism 210, for example a shape-changing mechanism, to change the shape of the device. At item 212, the user senses the device shape and, at item 214, moves their body based on the sensed device shape. The process represented in FIG. 6 can be repeated until the actual pointing direction 204 matches the desired pointing position 202, at which point the output of error item 200 is zero. When this is achieved, the device is pointing at the target object(s) and/or location(s) and the shape of the device is substantially straight. In specific examples, the device shape updates twenty times per second, based on SLAM and/or computer vision input, and user movements. As such, in this example, the device is configured to change shape based on closed-loop feedback, where the closed-loop feedback is based on a difference between the target position 202 in the environment and a position 204 in the environment at which the device is pointed. The shape of the device may update multiple times per second, giving closed-loop feedback.

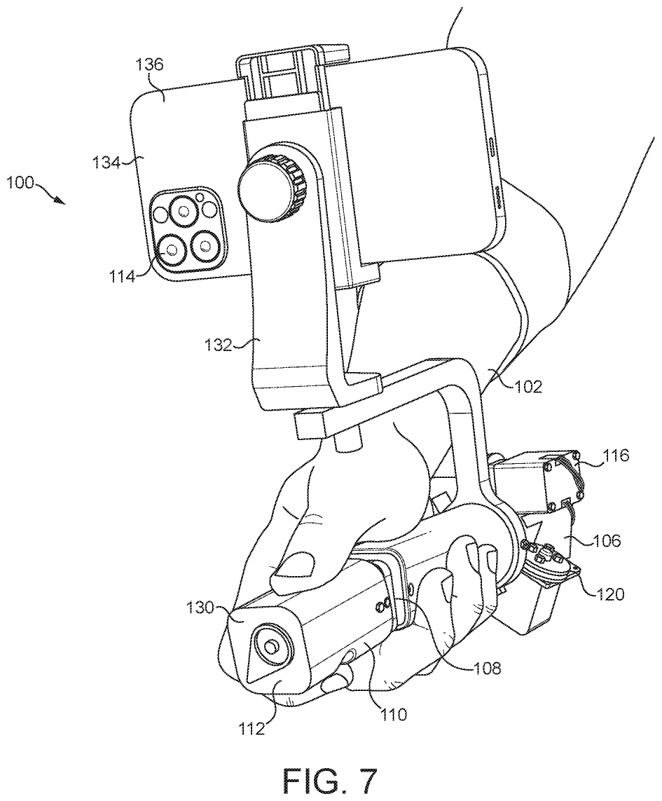

Referring to FIG. 7, there is shown another example of a sensory substitution device 100.

In this example, the device 100 comprises a handheld body portion 130, a smartphone mount portion 132, and a smartphone portion 134.

In this example, the handheld body portion 130 is generally rectangular cuboid in shape.

In this example, the smartphone portion 134 comprises a smartphone 136. In this example, the smartphone 136 comprises the one or more spatial sensors 114. In this example, the handheld body portion 130 does not comprise any spatial sensors.

In this example, the sensory substitution device 100 comprises the handheld body portion 130, the smartphone mount portion 132, and the smartphone portion 134. However, the sensory substitution device 100 may comprise fewer and/or different components in other examples. In accordance with this example, costs of the handheld body portion 130 can be kept low. Upgraded functionality may be enabled as new smartphones 136 are released. The handheld body portion 130 may have no sensors (such as GPS and IMU) on board and a camera 114 of the smartphone 136 may be used. It may also be easier to release and install software updates in this configuration.

In another example, the shape-change mechanism of the sensory substitution device 100 is comprised in a handheld component 130 of the sensory substitution device 100 and the one or more spatial sensors 114 are comprised in one or more on-the-person components of the sensory substitution device 100. An on-the-person component may be a handheld component 130 (held by a person) or may be a wearable component (worn by a person). Examples of wearable components include, but are not limited to, headsets and smart glasses. Examples of such headsets include, but are not limited to, AR and virtual reality (VR) headsets.

As such, the sensory substitution device 100 may be an on-the-person device having one or more handheld components 130 and one or more other on-the-person components, where an on-the-person component is, in use, on the person using the device 100. The on-the-person component may be on the person using the device 100 by being handheld or by being wearable. Each such component may have its own housing. Such a device configuration is operable in any environment in which the person is located without the need for external infrastructure, for example, Bluetooth™ beacons or availability of GPS reception, thus comprises a standalone sensory substitution device.

In some examples described herein, a target position 104 is represented in the centre of a frame captured by a sensor 114 of the sensory substitution device 100. This may be the case where the sensor 114 is arranged in the pointing direction of the sensory substitution device 100.

In other examples, the target position 104 may not be represented in the centre of a frame captured by a sensor 114 of the sensory substitution device 100. This may be the case where the sensor 114 is comprised in a wearable component and is not aligned with the pointing direction of the sensory substitution device 100. In such examples, the sensory substitution device 100 may be configured to calculate the pointing vector using, for example using a fiduciary marker on one or more of the on-the-person components or via other tracking by the spatial sensor(s) 114 even without fixed alignment between the handheld component 130 and the sensor 114.

Referring to FIG. 8, there is shown another example of a sensory substitution device in three different configurations.

In FIG. 8, the device is indicated with reference signs 100a, 100b, 100c in the first, second and third configurations respectively.

This example demonstrates tilt compensation functionality, and assumes that a target position (not visible) is above the device 100a, 100b, 100c. Tilt compensation allows the user to move their wrist in a natural fashion without receiving incorrect cues. As such, the device 100a, 100b, 100c comprises a tilt compensator. The tilt compensator may be hardware-based and/or software-based.

In the first configuration, the device 100a is at a 0-degree rotation, a target vector 138a points vertically upwards, and the device 100a is bent and pointed vertically upwards. In the second configuration, the device 100b is at a 45-degree rotation, a target vector 138b points vertically upwards again, and the device 100b is again bent and pointed vertically upwards with respect to the ground. Similarly, in the third configuration, the device 100c is at a 90-degree rotation, a target vector 138c points vertically upwards again, and the device 100c is again bent and pointed vertically upwards with respect to the ground. The rotation between the first, second and third configurations can readily be seen in the rotation of patterns 140a, 140b, and 140c on the front of the device 100a, 100b, 100c.

As such, in this example, the device 100a, 100b, 100c is pointed vertically upwards with respect to the ground in each of the first, second and third configurations, and adjusts its shape change to remain pointed vertically upwards even when the device 100a, 100b, 100c is tilted or rotated.

An IMU and/or a spatial sensor may be used to detect the tilt of the device 100a, 100b, 100c. Examples of spatial sensor include, but are not limited to a camera, a LIDAR sensor and an external virtual reality motion tracker. The device 100a, 100b, 100c is configured to adjust its shape-change motion accordingly. For example, the device 100a, 100b, 100c may determine an initial direction of shape change based on a 0-degree tilt angle and may transform that initial direction of shape change to derive a tilt-compensated direction of shape change based on the amount of tilt.

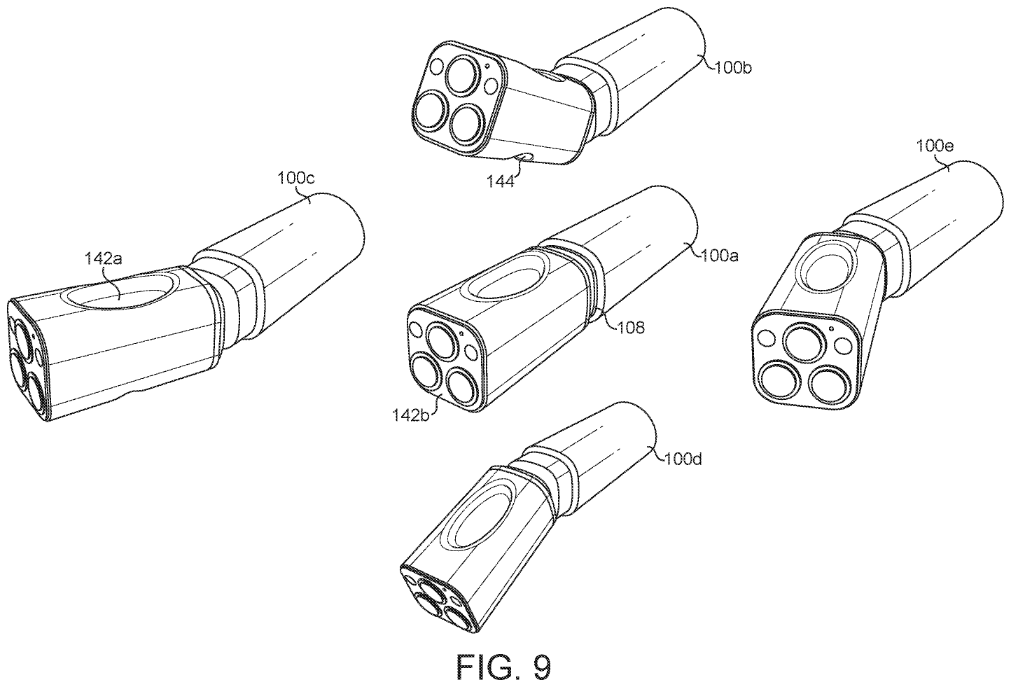

Referring to FIG. 9, there is shown another example of a sensory substitution device in five different configurations.

In FIG. 9, the device is indicated with reference signs 100a, 100b, 100c, 100d, 100e in the first, second, third, fourth and fifth configurations respectively.

FIG. 9 illustrates various bending directions of the example device 100a, 100b, 100c, 100d, 100e.

In the first configuration, the device 100a is straight. In the second configuration, the device 100b is upward-bending from the perspective of the user. In the third configuration, the device 100c is rightward-bending from the perspective of the user. In the fourth configuration, the device 100d is downward-bending from the perspective of the user. In the fifth configuration, the device 100e is leftward-bending from the perspective of the user.

In this example, the device 100a, 100b, 100c, 100d, 100e comprises a first recess 142a. The recess may also be referred to as a “notch”. A recess may leverage other sensory modalities of a user, such as sliding sensations and the edge detection capacities of the human fingertips.

In this example, the first recess 142a is in an upper surface of the device 100a, 100b, 100c, 100d, 100e. In this example, the first recess 142a is a thumb recess for a thumb of a user of the device 100a, 100b, 100c, 100d, 100e.

In this example, the device 100a, 100b, 100c, 100d, 100e comprises a second recess 142b. In this example, the second recess 142b is in a lower surface of the device 100a, 100b, 100c, 100d, 100e. In this example, the second recess 142b is a finger recess for a finger of a user of the device 100a, 100b, 100c, 100d, 100e.

In this example, the first and second recesses 142a, 142b are ergonomic recesses for the thumb and forefinger of the user. More generally, however, the first and second recesses 142a, 142b are for respective digits (of which a thumb and a finger are examples) of a hand of the user.

As such, shape-change can, in effect, be used between the thumb and forefinger of a user while the user has a ‘handle’ which can be held in their palm. By having the shape-change at the front of the device 100a, 100b, 100c, 100d, 100e, the device 100a, 100b, 100c, 100d, 100e can be relatively small and mechanically simple. The device 100a, 100b, 100c, 100d, 100e may also comprise a rigid section to contain components.

In this example, the device comprises a sensor suite 114. In this example, the sensor suite comprises a plurality of sensors 114. The plurality of sensors 114 may be comprise two or more sensors 114 of the same type as each other. The plurality of sensors 114 may be comprise two or more sensors 114 of different types from each other.

In this example, the device 100a, 100b, 100c, 100d, 100e comprises a shape-change portion 108 comprising a shape-change mechanism.

Although this example uses recesses, another type of tactile marker 142a, 142b may be used. For example, one or more ridges and/or triggers may be used in addition to, or as an alternative to, one or more recesses. Such tactile markers 142a, 142b encourage the user to hold and use the device 100a, 100b, 100c, 100d, 100e in the correct way.

One or more ridged sections may be combined with one or more shape-change sections. For example, multiple shape-change sections in combination with multiple rigid sections may allow the entire device 100a, 100b, 100c, 100d, 100e to bend along its length.

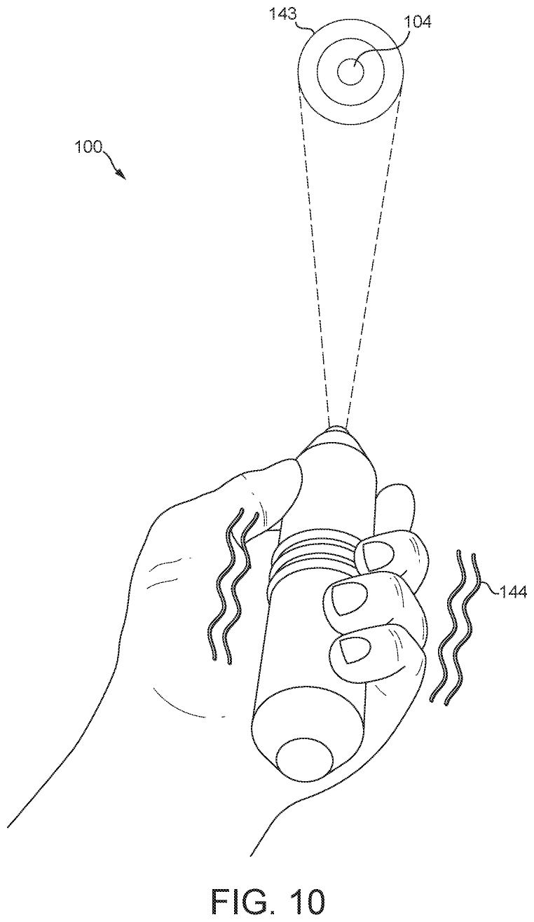

Referring to FIG. 10, there is shown another example of a sensory substitution device 100.

In this example, the device 100 provides an additional momentary stimulus (or stimuli) other than shape-change when the device 100 is pointed within an error bound 143 of the (exact) target position 104. The target position 104 may be associated with a target vector. The momentary stimulus is represented schematically in FIG. 10 by item 144. The stimulus 144 lets the user know they are pointed close to the target position 104. The stimulus 144 may be a continuous stimulus, such as a persistent vibration or audio alert. The stimulus 144 may be a temporal pattern of alerts, such as beeping or a vibration pattern.

For example, the device 100 may be configured such that, when the device 100 is pointed within a certain number of degrees, for example seven, of the target position 104, the momentary stimulus 144 is activated. This informs the user that they are pointing close to the target position 104.

In another example, the device 100 provides a momentary stimulus 144 (or stimuli) when the device 100 is pointed outside a given bound 143 of the (exact) target position 104. This may provide a warning that they are pointing outside the bound 143.

The device 100 may provide one type of stimulus 144 if the device 100 is pointed within a given error bound 143 and another type of stimulus 144 if the device 100 is pointed outside the or another given error bound 143.

In this example, the stimulus 144 comprises vibration. As such, the device 100 may start throbbing based on the closeness of the pointing of the user to the target position 104. However, vibration may numb the hand of the user and may be distracting. This vibration may take any frequency, magnitude or waveform and may be dynamic or transient in any of these aspects.

The stimulus 144 may comprise illumination. Some visually impaired users may be able to sense bright light, either of a certain colour or of any colour. More generally, the device 100 may incorporate programmable lighting to make use of the remaining vision of the user. It is surprising that this is effective for blind users, namely users with severe visual impairment.

As an alternative to, or in addition to, non-audible feedback, the stimulus 144 may comprise an audio cue.

The use of the momentary stimulus 144 drastically improves device performance by enabling a user to recognise easily when they have or have not acquired a target vector. The user can then, in effect, stop focusing on trying to locate the object 104, reducing cognitive load. Otherwise, there may be ambiguities as to whether or not the object or target direction 104 has been located.

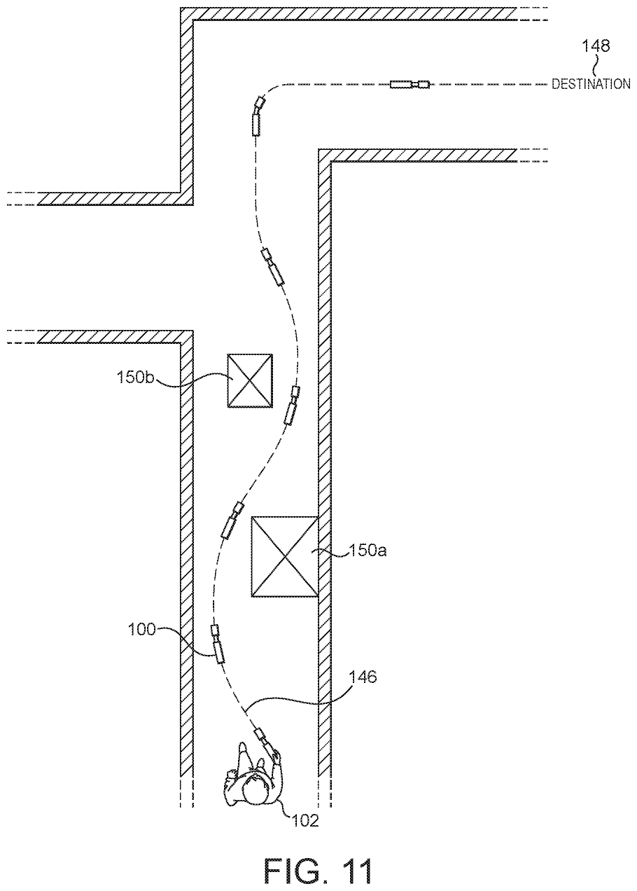

Referring to FIG. 11, there is shown an example sensory substitution device 100 providing positive feedback to a user 102. Such feedback may be considered to be ‘positive’ in that the device 100 positively points the user 102 along a path 146 the user 102 is to follow. The path may be a virtual path in that the path is not depicted in the real world.

In this example, the user 102 navigates along the path 146 to a destination 148 using the device 100. In this example, the path 146 is an optimal path and enables the user 102 to avoid multiple obstacles 150a, 150b in the environment. As such, the user 102 can use the device 100 to follow the path 146 whilst simultaneously avoiding obstacles 150a, 150b.

The device 100 may use one or more onboard sensors to detect the obstacles 150a, 150b and/or undertake-path planning. Examples of such sensors include, but are not limited to, GPS, LIDAR, digital imaging and RADAR.

The device 100 may use an additional haptic modality to indicate to the user 102 to move along a target vector. As such, the device 100 may indicate to the user 102 where to go, rather than where not to go. This differs from ‘negative’ feedback where, for example, the device 100 may vibrate if danger or potential danger is detected.

The device 100 may therefore be considered to be a device of guidance rather than a device of pure exclusion. A cane is, by contrast, a device of exclusion. The example device 100 may, for example, positively guide the user 102 across a field, which is not the purpose of a cane.

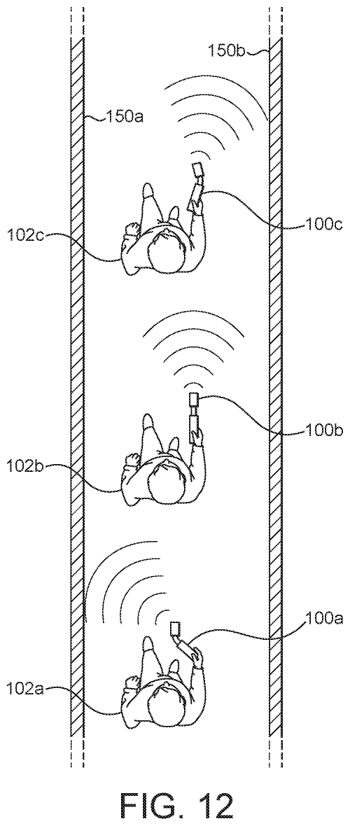

Referring to FIG. 12, there is shown an example sensory substitution device providing negative feedback to a user. Such feedback may be considered to be ‘negative’ in that the device warns the user of a danger or potential danger.

In FIG. 12, the user is shown in three different positions and the device is shown in three different respective configurations. In FIG. 12, the device is indicated with reference signs 100a, 100b, 100c in the first, second and third configurations respectively, and the user is indicated with reference signs 102a, 102b, 102c in the first, second and third positions respectively.

In this example, the environment comprises obstacles in the form of corridor walls or “edges” 150a, 150b.

This example shows how the user 102a, 102b, 102c can use the device 100a, 100b, 100c as an intuitive tool to detect the edges 150a, 150b of the corridor whilst navigating. When pointed at a wall or other obstacle, 150a, 150b, the device 100a, 100b, 100c deflects from the obstacle 150a, 150b to let the user 102a, 102b, 102c know of the presence of the obstacle 150a, 150b. This is a different mode from positive feedback.

This can also provide, in effect, a virtual cane. A virtual cane mimics a physical cane. However, there can be additional features of a virtual cane. For example, the ‘virtual length’ of the virtual cane may be adjusted. In other words, the distance from an obstacle or other object at which negative feedback is provided to the user may be adjusted. Initially, the distance may be relatively long and, over time, the distance may be shortened. Different distances may be used based on the risk associated with the obstacle in question, the competency of the user 102 in using the device 100a, 100b, 100c, or otherwise. A virtual cane may be more discrete than a physical cane. A virtual cane may be easier to store and transport than a physical cane. A virtual cane could still be used with a physical cane, for example attached to a physical cane if desired.

The device 100a, 100b, 100c may be selectively operable in the negative feedback mode, for example based on user input.

In more detail, in this example, in the first configuration, the device 100a is bent to the right, and the front portion is parallel to both walls 150a, 150b.

In the second configuration, the device 100b is straight and, again, the front portion is parallel to both walls 150a, 150b.

In the third configuration, the device 100c is bent to the left and, again, the front portion is parallel to both walls 150a, 150b.

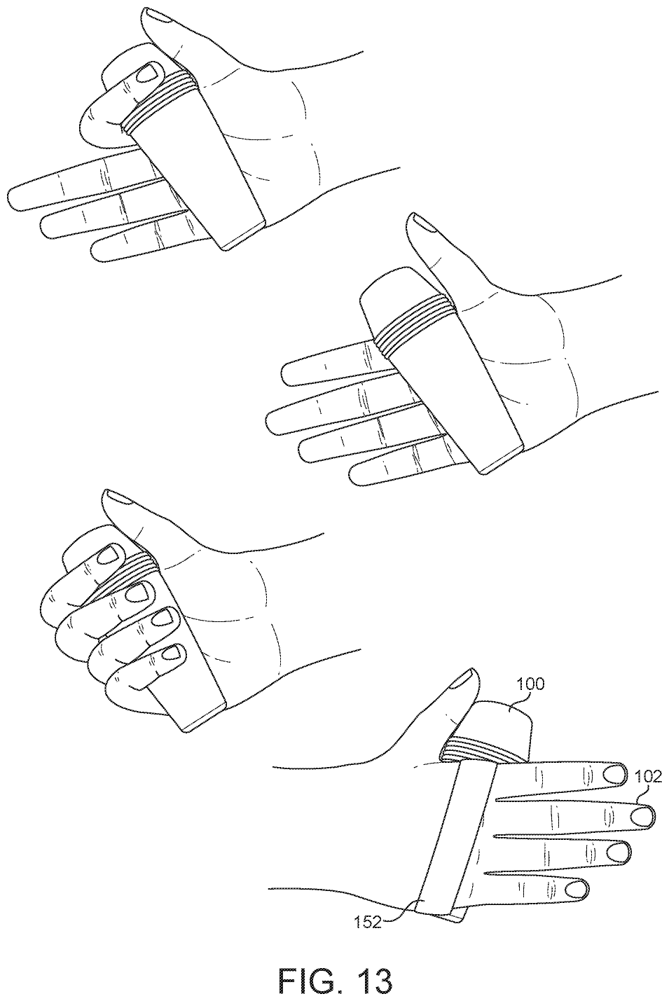

Referring to FIG. 13, there is shown another example of a sensory substitution device 100.

In this example, the device 100 comprises a hand strap 152. The hand strap 152 is connected, at both ends, to the device 100. In use, the user 102 inserts their hand between the hand strap 152 and the main body of the device 100 such that the device 100 is in the palm of the hand and the strap 152 is on the back of the hand. This enables the user 102 to move their fingers freely and feel the shape of the device 100 while still supporting the device 100.

As depicted in FIG. 13, when using the hand strap 152, the user 102 may still firmly grip the device 100, may touch the device 100 using their thumb and forefinger, or may release their grip of the device 100 entirely. Using just a thumb and forefinger can provide high resolution haptic communication with the user in view of the high sensitivity of the thumb and forefinger. Releasing grip altogether whilst having the hand strap 152 engaged enables hands-free operation, enabling, for example, for the user pick up or manipulate environmental objects with the same hand the device 100 is strapped to.

The hand strap 152 may be tight around the main part of the hand of the user 102 once the user 102 has slipped their hand through the strap 152. As explained above, the user 102 does not need to grip the device 100 in such situations. As such, the strap 152 can eliminate the need for the user 102 to support the device 100 while still enabling the user 102 to feel the shape of the device 100. As such, the user 102 does not need to hold the device 100, but can feel the device 100 knowing that the device 100 is supported, such that the device 100 almost ‘floats’ on the hand of the user 102. This also enables the user 102 to have their fingers free. This may enable them to push buttons on an elevator, to carry a cane, and so on. These benefits are surprising on a small, handheld device.

The strap 152 may have an adjustable tightness.

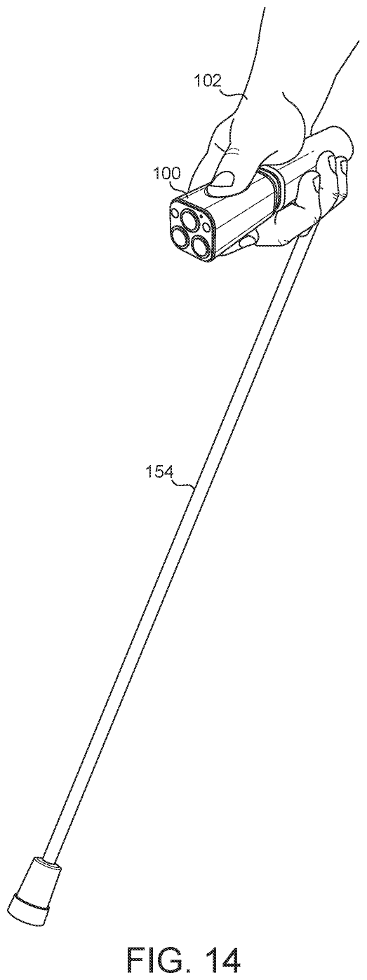

Referring to FIG. 14, there is shown another example of a sensory substitution device 100.

In this example, the device 100 is attached to a cane 154 of the user 102. The device 100 may be clipped onto the cane 154, for example.

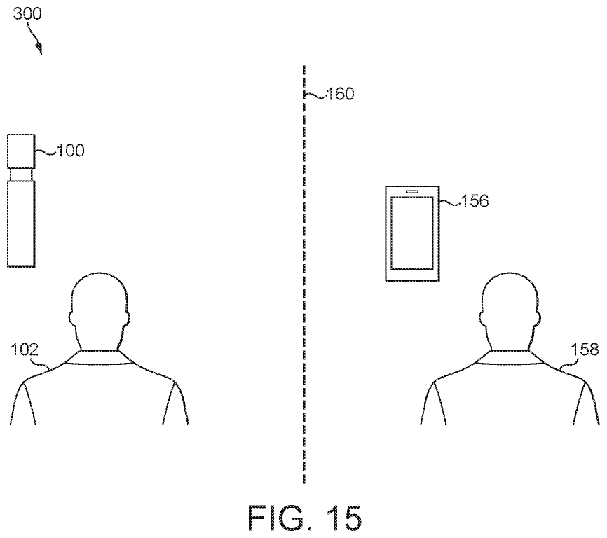

Referring to FIG. 15, there is shown an example of a system 300 comprising an example sensory substitution device 100.

This example relates to teleassistance, which may also be referred to as “remote assistance”.

In this example, the system 300 comprises a sensory substitution device 100 and a remote device 156. In this example, the sensory substitution device 100 is used by a user 102 and the remote device 156 is used by a remote entity 158. The user 102 may be referred to as the “assisted”, “assisted person”, or the like. The remote entity 158 may be a human or otherwise. The remote entity 158 may be referred to as an “assister”, “assisting person”, or the like. The assisting person 158 may be a person on the remote end of a video feed who is providing teleassistance to the assisted person 102. The assisted person 102 may be a person sending a video feed to the device 156 of the assisting person 158, and who will follow guidance provided by the assisting person 158.

The degree of remoteness, which is depicted schematically by line 160 in FIG. 15, can differ in different examples. The remote entity 158 may be in the same room as the user 102, a different room in the same building as the user 102, or much further away from the user 102. As such, “remote” should be understood broadly to mean not in exactly the same location as the user 102.

In this example, teleassistance is provided via digital markers.

In more detail, in examples, teleassistance is provided by having the assisting person 158 located in one place select a location to place a digital marker within the local environment of the assisted person 102 based on a live video feed from the location of the assisted person 102. The person 102 being assisted is then guided towards the digital marker using a non-visual interface (for example as described herein), audio and/or visual cues. This leverages human input to help people locate objects and/or navigate spaces, which may be superior to completely automated solutions.

Video calls can currently be used to aid a person who is in a different place from an assisting person. Typically, the assisting person and the person being assisted communicate using a mobile phone or smart glasses, with verbal instructions being provided in response to input from a live video feed. For example, a sighted helper may aid a visually impaired person to identify and/or locate objects, and navigate environments.

However, using verbal communication alone through a video call is highly ambiguous. Additionally, if the person being assisted moves the line of sight of the camera out of the location to which the assister is trying to direct the assisted, then the assisted will first need to be directed to point the camera in a particular direction before any useful guidance can be provided.

In examples, the assister 158 uses a remote video feed sent from the device 100 of the assisted user 102 to place a locational anchor in 3D space within the local environment of the assisted user 102. For example, the assister 158 may tap their finger on the appropriate screen location in a video feed displayed on the remote device 156.

The assister 158 may be able to pause the video feed from the assisted user 102. This gives the assister 158 time to comprehend the footage and place a digital marker accurately. The device 100 of the assisted person 102 and/or another device then calculates where the digital marker was placed, even if the assisted person 102 has moved from the original space.

The locational digital marker may thereby be placed in a position in 3D space within the local environment of the assisted user 102 by another person 158 who may be located anywhere in the world.

The locational digital marker may be used to indicate a direction for navigation. The digital marker may automatically update its position in the environment as the assisted user 102 moves. As such, the assisted user 102 can be guided along a particular directional vector without further assistance from the assister 158.

If a digital marker is placed on an object, object detection inference can be used to identify automatically what the object is. Conversely, object detection can be used to identify an object and place a digital marker on the identified object.

When the digital marker has been placed, the assisted user 102 may be guided towards the digital marker using a haptic interface, automated audio cues and/or visual cues from their device 100.

In more detail, the person seeking assistance, namely the assisted person 102, may use the device 100, to initiate or otherwise establish a video call with another person, namely the assister 158, who may be located anywhere in the world. The device 100 may comprise a smartphone, smart glasses, and/or a sensory substitution device such as described herein. The assisting person 158 sees the live video stream from the device 100 of the assisted user 102 and can tap their finger on the screen of their own device 156 to place an digital marker within the local environment of the assisted user 102. The device 156 of the assisting person 158 may be a smartphone, tablet computing device, laptop computer, desktop computer, etc. The digital marker is registered by the device 100 of the assisted user 102. The device 100 may track its own location within 3D space. The device 100 may be used to draw the attention of the user 102 towards the digital marker, for example using audio, visual and/or haptic cues.

Such examples may be used to help the assisted user 102 navigate spaces, identify objects and/or identify other points of interest.

In a specific implementation, the assisting person 158 can pause and/or rewind the video feed. In the meantime, the device 100 of the assisted person 102 is tracking its movements while the video is paused and/or otherwise being reviewed. The assister 158 can then review the footage and place a digital marker in a place in which the assisted user 102 was recently located

As such a vector may be communicated by directing a user to point along a target vector. The pointing gesture is a universal hand signal to indicate a location that is observed even in congenitally blind children. This provides improved efficacy compared to just touch alone.

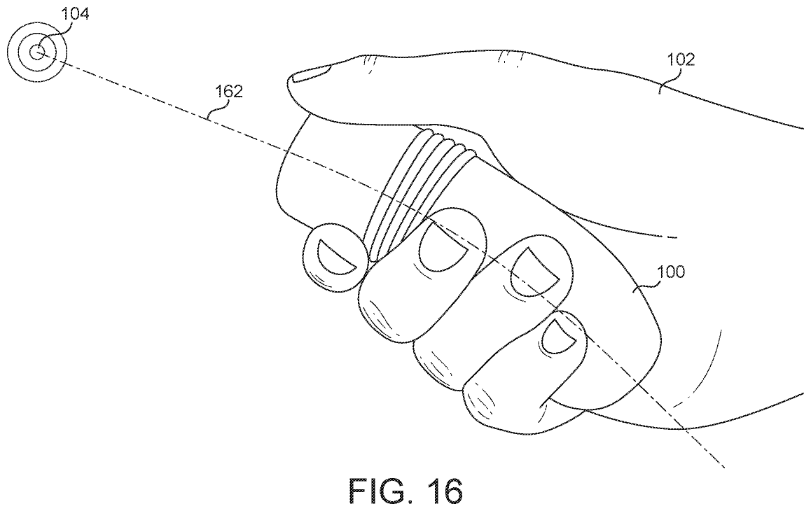

Referring to FIG. 16, there is shown an example in which the device 100 is pointing towards a target 104 such that an extrapolation of the device centre line 162 is approximately aligned with the target 104. The device centre line 162 need not be straight. For example, the device 100 may have a curved or other ergonomic shape. In this example, the device 100 works to align the centre line 162 with the target 104. The device 100 achieves this by changing shape such that, when returned to the home position, the centre line 162 will align with the target 104. In this example, the centre line 162 of the device 100 is along the longest axis of the device 100. In this example the sensory substitution device 100 includes a handheld shape-change mechanism.

Various additional examples will now be described.

In some examples, the user 102a, 102b, 102c can direct the device 100, 100a, 100b, 100c, 100d, 100e to navigate to locations 104 using only their voice though natural language processing. The device 100, 100a, 100b, 100c, 100d, 100e pairs with another device, such as a smartphone. Applications, such as mapping applications, are also interfaced. The user 102a, 102b, 102c walks with the device 100, 100a, 100b, 100c, 100d, 100e, holding the device 100, 100a, 100b, 100c, 100d, 100e forward-facing like a flashlight. In examples, the forward-facing camera 114, 114a, 114b, 114c feeds video to a computer vision application to identify important navigational features 104 which are typically identified by a guide dog. Examples of such navigational features include, but are not limited to, pavements and zebra crossings. The user 102a, 102b, 102c is kept from walking into a road by navigational guidance though the touch sense.

In some examples, the user 102a, 102b, 102c can use the device 100, 100a, 100b, 100c, 100d, 100e to ‘read’ text using text-to-speech functionality. For example, the user 102a, 102b, 102c could aim the device 100, 100a, 100b, 100c, 100d, 100e at a paragraph of text and use their voice to command the device 100, 100a, 100b, 100c, 100d, 100e to read the text.

In some examples, the user 102a, 102b, 102c can use the forward-facing camera 114, 114a, 114b, 114c on the device 100, 100a, 100b, 100c, 100d, 100e to magnify items. Images of such items can be streamed to a display, such as a smartphone screen or smart glasses display, for closer inspection by the user 102a, 102b, 102c.

In some examples, the device 100, 100a, 100b, 100c, 100d, 100e can be used in a mode in which the user 102a, 102b, 102c aims the device 100, 100a, 100b, 100c, 100d, 100e at an object of interest 104, initiates a command (for example by pressing a button and/or issuing a voice command), and the device 100, 100a, 100b, 100c, 100d, 100e calls out the largest object 104 identified in the camera frame.

In some examples, the device 100, 100a, 100b, 100c, 100d, 100e does not have any sensors 114, 114a, 114b, 114c, such as forward-facing sensors 114, 114a, 114b, 114c. Instead, the device 100, 100a, 100b, 100c, 100d, 100e is a shape-changing, human-machine interface that can be used to convey directional information based on sensory information provided by other technologies. Examples of such other technologies include, but are not limited to, a smartphone, Bluetooth™ beacons, smart glasses, GPS, or wearable technology.

In some examples, the device 100, 100a, 100b, 100c, 100d, 100e is handheld in that the weight of the device 100, 100a, 100b, 100c, 100d, 100e is held off the ground only by the hand of the user 102a, 102b, 102c. However, the device 100, 100a, 100b, 100c, 100d, 100e may be supported by another object in other examples. Examples of other such objects include, but are not limited to, guide canes, walking sticks and dog leashes.

In some examples, the device 100, 100a, 100b, 100c, 100d, 100e is used by a visually impaired user 102a, 102b, 102c. However, the device 100, 100a, 100b, 100c, 100d, 100e may be used by a person who is not visually impaired. For example, the device 100, 100a, 100b, 100c, 100d, 100e could be used in a warehouse to help a user who may or may not be visually impaired locate items more efficiently than they would be able to do without such a device 100, 100a, 100b, 100c, 100d, 100e.

In some examples, the device 100, 100a, 100b, 100c, 100d, 100e is configured to perform non-linear actuation. In such examples, an amount of shape change of the device 100, 100a, 100b, 100c, 100d, 100e correlates non-linearly to an amount of error between a pointing position and a target position 104. For example, the rate (or other amount) of change of actuation with respect to error, at small errors, may be greater than the rate (or other amount) of change of actuation with respect to error, at higher errors. The error may correspond to the difference between the desired pointing direction and the actual pointing direction, such as described above with reference to FIG. 6. This may improve the pointing accuracy of the user 102, 102a, 102b, 102c.

In some examples, the device 100, 100a, 100b, 100c, 100d, 100e is optimised for the user 102, 102a, 102b, 102c. This may use machine learning or otherwise. As such different devices 100, 100a, 100b, 100c, 100d, 100e may be tuned for each user to have per-user critical damping. Such tuning may be based on temporal usage. Such tuning may use a Proportional-Integral-Derivative (PID) controller to reduce overshoot and, hence, increase the likelihood of the user 102, 102a, 102b, 102c promptly pointing at the desired target position 104.

In some examples, the device 100, 100a, 100b, 100c, 100d, 100e is optimised for an intuitive path of motion. For example, the device 100, 100a, 100b, 100c, 100d, 100e may be configured to prevent a user 102, 102a, 102b, 102c from being directed to move the device 100, 100a, 100b, 100c, 100d, 100e over their head. Even if a path to a target position 104 that involves the device 100, 100a, 100b, 100c, 100d, 100e being moved over the head of a user 102, 102a, 102b, 102c is a mathematically and/or spatially optimal path, it may not be a biomechanically optimal path. In more detail, the most efficient path (mathematically and/or spatially) may feel unnatural for a user 102, 102a, 102b, 102c. As explained above, if a target vector is located behind a user 102, 102a, 102b, 102c, then the device 100, 100a, 100b, 100c, 100d, 100e may otherwise bend upwards to direct the user 102, 102a, 102b, 102c to move the device 100, 100a, 100b, 100c, 100d, 100e in a path that is over their head, rather than bending to the left or right to indicate to the user 102, 102a, 102b, 102c to turn around. In contrast, by directing the user 102, 102a, 102b, 102c on the biomechanically optimal path, more natural guidance may be provided.

In some examples, one or more portions of the device 100, 100a, 100b, 100c, 100d, 100e other than the front of the device 100, 100a, 100b, 100c, 100d, 100e comprise one or more sensors 114, 114a, 114b, 114c. As such, sensors 114, 114a, 114b, 114c may be placed at strategic geometric locations around the device 100, 100a, 100b, 100c, 100d, 100e. One or more sensors 114, 114a, 114b, 114c may still be at the front of the device 100, 100a, 100b, 100c, 100d, 100e in such examples. This can optimise performance of SLAM, odometry and detection. Such sensors 114, 114a, 114b, 114c may take various forms. For example, such sensors 114, 114a, 114b, 114c may comprise cameras, including but not limited to low-resolution cameras, infrared cameras, and so on. This facilitates ‘inside-out’ odometry, namely determination of movement relative to a previous position. For example, a sensor 114, 114a, 114b, 114c may point downwards and backwards relative to the device 100, 100a, 100b, 100c, 100d, 100e, so as to sense an area directly in front of the user 102, 102a, 102b, 102c. Such sensor(s) 114, 114a, 114b, 114c may be placed such that the hand of the user does not occlude or limit the field of view of the sensor(s) 114, 114a, 114b, 114c. Such placement may be such that the field of view of the sensor(s) 114, 114a, 114b, 114c is not occluded by either a right hand or a left hand of a user 102, 102a, 102b, 102c, for ambidextrous usage. More generally, the device 100, 100a, 100b, 100c, 100d, 100e may have an ambidextrous design configured for ambidextrous usage.

In some examples, the device 100, 100a, 100b, 100c, 100d, 100e has a curved handle. This may fit the hand of the user 102, 102a, 102b, 102c more ergonomically than with a straight device. A straight handle may push on the thumb of the user 102, 102a, 102b, 102c, but can lead to the device having the same feel as a cane.

In some examples, the user 102, 102a, 102b, 102c is trained to point along arbitrary target vectors through an automated induction game. This may involve prompting the user 102, 102a, 102b, 102c to point to a real-world target and/or to a synthetic (or ‘virtual’) target. This may also be used to calibrate device parameters or coefficients for the particular user 102, 102a, 102b, 102c in question.

Calibration may, alternatively or additionally, involve identifying which colours, if any, the user 102, 102a, 102b, 102c can see particularly well. Light of such colour(s) may be used to provide feedback to blind and partially sighted users 102, 102a, 102b, 102c as described herein.

In some examples, the weight of the device 100, 100a, 100b, 100c, 100d, 100e is balanced such that the user 102, 102a, 102b, 102c can hold the device 100, 100a, 100b, 100c, 100d, 100e in their hand without needing to support the shape-changing portion of the device 100, 100a, 100b, 100c, 100d, 100e. In particular, the centre of mass of the device 100, 100a, 100b, 100c, 100d, 100e may balance in the palm of the hand of the user 102, 102a, 102b, 102c. If the user 102, 102a, 102b, 102c has to exert an effort to support the device 100, 100a, 100b, 100c, 100d, 100e, in particular the shape-changing portion, it may be more difficult for the user 102, 102a, 102b, 102c to sense the device shape and changes to the device shape.

In some examples, the user 102, 102a, 102b, 102c can switch between objects identified in a camera frame by use of user input. Such user input may be active user input such as, but not limited to, speech.

For example, the device 100, 100a, 100b, 100c, 100d, 100e may lock (or ‘latch’) onto an identified object. The device 100, 100a, 100b, 100c, 100d, 100e may then ‘flick’ between the identified object and one more other identified objects. For example, if the user 102, 102a, 102b, 102c is looking for a coffee mug, there may be multiple instances detected within one camera frame. The device 100, 100a, 100b, 100c, 100d, 100e may prompt the user 102, 102a, 102b, 102c to point to the nearest coffee mug to the user 102, 102a, 102b, 102c. However, the user 102, 102a, 102b, 102c may be able to move the device 100, 100a, 100b, 100c, 100d, 100e to lock onto a different coffee mug. Hysteresis may be used to limit the extent to which the device 100, 100a, 100b, 100c, 100d, 100e ‘flicks’ between different identified objects.

In some examples, cloud-based object recognition may be used. This may reduce computational burden on the device 100, 100a, 100b, 100c, 100d, 100e. One or more digital markers may be set at the same time as sending camera frame data to the cloud. For example, for a given frame of video, digital markers may be set in the middle of bounding boxes around all identified objects in the frame. Cloud-based object detection inference may be used and the device 100, 100a, 100b, 100c, 100d, 100e may account for the processing time delay.

In some examples, the device 100, 100a, 100b, 100c, 100d, 100e is configured to use coded pulses of vibration to communicate, for example to deaf-blind persons. For example, the device 100, 100a, 100b, 100c, 100d, 100e may be used in this manner to communicate text.

In some examples, the device 100, 100a, 100b, 100c, 100d, 100e comprises one or more absolute encoders. This can reduce or eliminate the need for a start-up procedure to know the device shape-change mechanism position.

In some examples, the device 100, 100a, 100b, 100c, 100d, 100e comprises one or more piston-based actuators. Pistons push, whereas tendons pull.

In some examples, the device 100, 100a, 100b, 100c, 100d, 100e is operable to generate an alert to enable the user 102, 102a, 102b, 102c to locate the device 100, 100a, 100b, 100c, 100d, 100e. The alert may be an audio alarm, a vibration alert, or otherwise.

In some examples, a target position 104 may correspond to a marker. An example of a marker is a pre-existing, persistent digital marker. Such markers may have been ‘placed’ on a map of an environment prior to the user 102, 102a, 102b, 102c being in the environment. The marker positions may correspond to points of interest in the environment. Such markers may correspond to digital markers. Such markers may correspond to fiducial markers. Such markers may be placed manually, prior to the user 102, 102a, 102b, 102c being in the environment concerned. Such markers may therefore differ from automatically recognised markers and markers placed by teleassistance.

In some examples, digital marker points are used to interpolate a path through an environment. This enables 3D spatial guidance. As explained above, an AR anchor is a type of digital marker. However, other types of digital marker may be used.

In some examples, the device 100, 100a, 100b, 100c, 100d, 100e is configured to project such a digital marker into the real world in a position corresponding to that of the digital marker. Such projection may involve a ‘goes before optics’ (gobo) projector. A gobo projector may project a design, such as a logo, onto a surface.

In some examples, the device 100, 100a, 100b, 100c, 100d, 100e comprises one or more removable and/or interchangeable components. For example, the device 100, 100a, 100b, 100c, 100d, 100e may comprise one or more removable and/or interchangeable input components. Examples of such components include, but are not limited to, joypads and triggers. Another example of a removable and/or interchangeable component is a removable and/or interchangeable head. For example, different heads may comprise different sensor suites. As another example, one or more removable and/or interchangeable components may provide the device 100, 100a, 100b, 100c, 100d, 100e with waterproof functionality whereas the device 100, 100a, 100b, 100c, 100d, 100e may not be waterproof without such component(s).

In some examples, the device 100, 100a, 100b, 100c, 100d, 100e is water-resistant. For example, the shape-change mechanism may be sealed such that the shape-change mechanism is itself water-resistant.

In some examples described above, shape-change is used to indicate distance. In other examples, a secondary modality (other than shape-change) is used to indicate distance and may, surprisingly, be more effective at indicating distance than shape-change. For example, a small bump moving over the thumb or forefinger of the user 102, 102a, 102b, 102c may provide a haptic modality. In some examples, distance-based feedback is continuous. For example, temporal vibration may be used to indicate distance, with the vibrations getting faster and slower as the user 102, 102a, 102b, 102c gets closer to and further from the target position 104 respectively. In other examples, distance-based feedback may be persistent or intermittent. For example, the distance-based feedback may be activated when the user 102, 102a, 102b, 102c gets within a threshold distance of the target position 104 and may be deactivated when the user 102, 102a, 102b, 102c is outside the or another threshold distance from the target position. The secondary modality may use an oscillator to provide a pulling or tugging sensation. Such sensation may be based on a pulling vector. The oscillator may be in the front of the device 100, 100a, 100b, 100c, 100d, 100e. In another example, an inverted trigger may indicate distance. For example, the device 100, 100a, 100b, 100c, 100d, 100e may cause an inverted trigger to extend from and retract towards the device 100, 100a, 100b, 100c, 100d, 100e as distance to the target position 104 increases and decreases respectively, or vice versa.

In some examples described above, a shape-change mechanism provides kinaesthetic output to a user 102, 102a, 102b, 102c of the device 100, 100a, 100b, 100c, 100d, 100e. Another type of force-based mechanism may be used in other examples. Examples of other types of force-based mechanism include, but are not limited to, gyroscopes and asymmetrically excited linear oscillators. As such, a shape-change mechanism and/or another type of force-based mechanism (of which gyroscopes and asymmetrically excited linear oscillators are specific examples) may be used. In examples, such a force-based mechanism does not use vibration or audio to provide the kinaesthetic output and, as such, may be considered to provide non-vibratory, non-audio feedback.

In some examples, the user 102, 102a, 102b, 102c may use a holster with a pouch to carry the device 100, 100a, 100b, 100c, 100d, 100e when not in use. Alternatively, the device 100, 100a, 100b, 100c, 100d, 100e may be carried in a different manner when not in use. For example, the user 102, 102a, 102b, 102c may wear a belt to which the device 102, 102a, 102b, 102c can be attached magnetically.

Although specific examples are described herein, other examples are envisaged. Such other examples may use one or more features from one or more examples described herein. Such other examples may use one or more features not described herein.

The following numbered clauses of the present description correspond to the claims of UK patent application no. 2118227.4, from which the present application claims priority, as filed. The claims of the present application as filed can be found after the heading “Claims”.
1. A sensory substitution device comprising:
   a spatial sensor configured to provide spatial sensor data indicative of a spatial representation of an environment in which the sensory substitution device is located; and
   a shape-change mechanism operable to cause the sensory substitution device to change shape, based on the spatial sensor data, to provide kinaesthetic output to a user of the sensory substitution device, wherein the kinaesthetic output is indicative of a target position in the environment.
2. A sensory substitution device according to clause 1, wherein the change of shape is in at least one degree of freedom.
3. A sensory substitution device according to clause 1 or 2, wherein the change of shape is in at least two degrees of freedom.
4. A sensory substitution device according to any of clauses 1 to 3, wherein the change of shape is in three degrees of freedom.
5. A sensory substitution device according to any of clauses 1 to 4, wherein the sensory substitution device comprises an elongate body and wherein the shape-change mechanism is operable to cause the elongate body of the sensory substitution device to change shape.
6. A sensory substitution device according to any of clauses 1 to 5, wherein at least a portion of the sensory substitution device is substantially cylindrical.
7. A sensory substitution device according to any of clauses 1 to 6, wherein the sensory substitution device comprises a gripping portion configured to be gripped by the user.
8. A sensory substitution device according to any of clauses 1 to 7, wherein the sensory substitution device is a handheld sensory substitution device.
9. A sensory substitution device according to any of clauses 1 to 8, wherein the sensory substitution device is configured to change shape based on closed-loop feedback, the closed-loop feedback based on a difference between the target position and a position in the environment at which the sensory substitution device is pointed.
10. A sensory substitution device according to any of clauses 1 to 9, wherein the change of shape comprises bending of the sensory substitution device.
11. A sensory substitution device according to any of clauses 1 to 10, wherein the shape-change mechanism is configured such that the sensory substitution device is substantially straight when the sensory substitution device is pointed at the target position.
12. A sensory substitution device according to any of clauses 1 to 11, wherein the change of shape comprises stretching and/or compressing of the sensory substitution device.
13. A sensory substitution device according to any of clauses 1 to 12, wherein the target position is a position determined using computer vision.
14. A sensory substitution device according to any of clauses 1 to 13, wherein the target position is a position determined using LIDAR.
15. A sensory substitution device according to any of clauses 1 to 14, wherein the target position is a position determined using ultrasound.
16. A sensory substitution device according to any of clauses 1 to 15, wherein the target position is a position determined using infrared.
17. A sensory substitution device according to any of clauses 1 to 16, wherein the target position is a position identified based on a voice input being processed using natural language processing.
18. A sensory substitution device according to any of clauses 1 to 17, wherein the sensory substitution device is operable to communicate verbally a distance from the sensory substitution device to the target position.
19. A sensory substitution device according to any of clauses 1 to 18, wherein the shape-change mechanism comprises elastomeric material.
20. A sensory substitution device according to any of clauses 1 to 19, wherein the shape-change mechanism is configured to cause the sensory substitution device to return to an equilibrium shape when the sensory substitution device is powered off.
21. A sensory substitution device according to any of clauses 1 to 20, wherein the sensory substitution device is configured to be controlled using SLAM.
22. A sensory substitution device according to any of clauses 1 to 21, wherein the device comprises object identification functionality.
23. A sensory substitution device according to any of clauses 1 to 22, wherein the sensory substitution device comprises a microcontroller and wherein the microcontroller is configured to control the shape-change mechanism based on the spatial sensor data.
24. A sensory substitution device according to any of clauses 1 to 23, wherein the sensory substitution device is operable to be controlled by at least one person other than the user while the user is using the sensory substitution device.
25. A sensory substitution device comprising:
   a sensor operable, in use, to output sensor data representative of an environment in which the sensory substitution device is being used by a user of the sensory substitution device; and
   a mechanism operable to cause the sensory substitution device to change shape, based on the output data, with motion that is not plane-constrained, whereby to provide proprioceptive output to the user.

1. A sensory substitution device comprising:
a spatial sensor configured to provide spatial sensor data indicative of a spatial representation of an environment in which the sensory substitution device is located; and
a shape-change mechanism operable to cause the sensory substitution device to change shape, based on the spatial sensor data, to provide kinaesthetic output to a user of the sensory substitution device, wherein the kinaesthetic output is indicative of a target position in the environment.

2. A sensory substitution device according to claim 1, wherein the change of shape is in at least one degree of freedom.

3. A sensory substitution device according to claim 1 or 2, wherein the change of shape is in at least two degrees of freedom.

4. A sensory substitution device according to any of claims 1 to 3, wherein the change of shape is in three degrees of freedom.

5. A sensory substitution device according to any of claims 1 to 4, wherein the sensory substitution device comprises an elongate body and wherein the shape-change mechanism is operable to cause the elongate body of the sensory substitution device to change shape.

6. A sensory substitution device according to any of claims 1 to 5, wherein at least a portion of the sensory substitution device is substantially cylindrical.

7. A sensory substitution device according to any of claims 1 to 6, wherein the sensory substitution device comprises a gripping portion configured to be gripped by the user.

8. A sensory substitution device according to any of claims 1 to 7, wherein the sensory substitution device is a handheld sensory substitution device.

9. A sensory substitution device according to any of claims 1 to 8, wherein the sensory substitution device is configured to change shape based on closed-loop feedback, the closed-loop feedback being based on a difference between the target position and a position in the environment at which the sensory substitution device is pointed.

10. A sensory substitution device according to any of claims 1 to 9, wherein the change of shape comprises bending of the sensory substitution device.

11. A sensory substitution device according to any of claims 1 to 10, wherein the shape-change mechanism is configured such that the sensory substitution device is substantially straight when the sensory substitution device is pointed at the target position.

12. A sensory substitution device according to any of claims 1 to 11, wherein the change of shape comprises stretching and/or compressing of the sensory substitution device.

13. A sensory substitution device according to any of claims 1 to 12, wherein the target position is a position determined using computer vision.

14. A sensory substitution device according to any of claims 1 to 13, wherein the target position is a position determined using LIDAR.

15. A sensory substitution device according to any of claims 1 to 14, wherein the target position is a position determined using ultrasound.

16. A sensory substitution device according to any of claims 1 to 15, wherein the target position is a position determined using infrared.

17. A sensory substitution device according to any of claims 1 to 16, wherein the target position is a position identified based on a voice input being processed using natural language processing.

18. A sensory substitution device according to any of claims 1 to 17, wherein the sensory substitution device is operable to communicate verbally a distance from the sensory substitution device to the target position.

19. A sensory substitution device according to any of claims 1 to 18, wherein the shape-change mechanism comprises elastomeric material.

20. A sensory substitution device according to any of claims 1 to 19, wherein the shape-change mechanism is configured to cause the sensory substitution device to return to an equilibrium shape when the sensory substitution device is powered off.

21. A sensory substitution device according to any of claims 1 to 20, wherein the sensory substitution device is configured to be controlled using SLAM.

22. A sensory substitution device according to any of claims 1 to 21, wherein the sensory substitution device comprises object identification functionality.

23. A sensory substitution device according to any of claims 1 to 22, wherein the sensory substitution device comprises a microcontroller and wherein the microcontroller is configured to control the shape-change mechanism based on the spatial sensor data.

24. A sensory substitution device according to any of claims 1 to 23, wherein the sensory substitution device is operable to be controlled by at least one person other than the user while the user is using the sensory substitution device.

25. A sensory substitution device according to claim 24, wherein the sensory substitution device is operable to be controlled by the at least one person based at least in part on video data transmitted to a device of the at least one person, the video data representing the environment in which the sensory substitution device is located.

26. A sensory substitution device according to any of claims 1 to 25, wherein the sensory substitution device is operable to switch from tracking a first identified object to tracking a second identified object based on user input.

27. A sensory substitution device according to any of claims 1 to 26, wherein the sensory substitution device is configured to perform tilt compensation to compensate for tilting of the sensory substitution device.

28. A sensory substitution device according to any of claims 1 to 27, wherein the sensory substitution device is configured to provide the kinaesthetic output to the user of the sensory substitution device based at least in part on one or more digital markers in the environment.

29. A sensory substitution device according to any of claims 1 to 28, wherein the sensory substitution device comprises a hand strap to hold a palm of the user against a body of the sensory substitution device.

30. A sensory substitution device according to any of claims 1 to 29, wherein the sensory substitution device is configured to use one or more stimuli to indicate that the user is pointing the sensory substitution device within a given error bound of the target position.

31. A sensory substitution device according to any of claims 1 to 29, wherein the sensory substitution device is configured to use one or more stimuli to indicate that the user is not pointing the sensory substitution device within a given error bound of the target position.

32. A sensory substitution device according to any of claims 1 to 31, wherein the sensory substitution device comprises at least one tactile marker for at least one digit of at least one hand of the user.

33. A sensory substitution device according to any of claims 1 to 32, wherein the kinaesthetic output is indicative of a path between the sensory substitution device and the target position, wherein the path corresponds to a biomechanically optimal path to the target position relative to a different, mathematically and/or spatially optimal path to the target position

34. A sensory substitution device according to any of claims 1 to 33, wherein the sensory substitution device comprises one or more light sources.

35. A sensory substitution device according to any of claims 1 to 34, wherein the sensory substitution device is configured to alert the user in response to detecting a danger and/or a potential danger.

36. A sensory substitution device according to any of claims 1 to 35, wherein the target position is a position determined using infrared.

37. A sensory substitution device according to any of claims 1 to 36, wherein the sensory substitution device is configured to perform non-linear actuation, wherein an amount of shape change of the sensory substitution device correlates non-linearly to an amount of error between a pointing position and the target position.

38. A sensory substitution device comprising:
a sensor operable, in use, to output sensor data representative of an environment in which the sensory substitution device is being used by a user of the sensory substitution device; and
a mechanism operable to cause the sensory substitution device to change shape, based on the output data, with motion that is not plane-constrained, whereby to provide proprioceptive output to the user.

39. A sensory substitution device comprising:
a shape-change mechanism operable to cause the sensory substitution device to change shape, based on spatial sensor data captured by a spatial sensor, to provide kinaesthetic output to a user of the sensory substitution device, wherein the kinaesthetic output is indicative of a target position.

40. A sensory substitution device comprising:
a force-based mechanism operable to cause the sensory substitution device to provide kinaesthetic output to a user of the sensory substitution device based on spatial sensor data captured by a spatial sensor, wherein the kinaesthetic output is indicative of a target position.

41. A sensory substitution device comprising:
a force-based mechanism operable to cause the sensory substitution device to provide kinaesthetic output to a user of the sensory substitution device, wherein the kinaesthetic output is indicative of a path between the sensory substitution device and a target position, and wherein the path corresponds to a biomechanically optimal path to the target position relative to a different, mathematically and/or spatially optimal path to the target position.

42. A sensory substitution device comprising:
an elongate body; and
a mechanism operable to cause the sensory substitution device to provide kinaesthetic output to a user of the sensory substitution device based on spatial sensor data captured by a spatial sensor, wherein the kinaesthetic output directs the user to point the elongate body of the sensory substitution device at a target position.

43. A sensory substitution device comprising:
a mechanism operable to cause the sensory substitution device to provide kinaesthetic output to a user of the sensory substitution device; and
a tilt compensator to compensate the kinaesthetic output for tiling of the sensory substitution device by the user.

44. A sensory substitution device comprising a mechanism operable to cause the sensory substitution device to provide kinaesthetic output to a user of the sensory substitution device, wherein the substitution device is operable to provide kinaesthetic output to guide a user of the sensory substitution device and is also operable to provide kinaesthetic output to alert the user to the presence of an object.

45. A shape-changing sensory substitution device configured to perform non-linear actuation, wherein an amount of shape change of the sensory substitution device correlates non-linearly to an amount of error between a pointing position and a target position.
